(19) United States
(12) Patent Application Publication
(10) Pub. No.: US 2022/0396206 A1
(43) Pub. Date: Dec. 15, 2022

(54) Motorised Vehicle Mirrors

(71) Applicant: Shane Miles, Arundel (AU)

(72) Inventor: Shane Miles, Arundel (AU)

(21) Appl. No.: 17/633,873

(22) PCT Filed: Aug. 6, 2020
(86) PCT No.: PCT/AU2020/050810

§ 371 Date: Feb. 8, 2022

(30) Foreign Application Priority Data
Aug. 8, 2019 (AU) 2019902836

(51) Int. Cl. B60R 1/074; B60R 1/078

(52) U.S. Cl. CPC B60R 1/074; B60R 1/078

(57) ABSTRACT

A towing mirror including a mount adapted to be mounted to a vehicle cabin, an extension component including a first member and a second member, one of said first and second members including one or more tracks and the other including one or more carriages, said one or more tracks and said one or more carriages being arranged such that said one or more carriages run on said one or more tracks whereby said second member may move linearly relative to said first member from a retracted position to an extended position and vice versa, and a mirror component operatively connected to said second member.

This invention relates to vehicle mirrors, particularly mirrors of the type intended to be mounted outside the cabin and more particularly mirrors of the type known as “towing mirrors”.

Towing mirrors are typically fitted to vehicles when towing caravans, fifth wheelers or other vehicles in order to extend the rearward line of sight of the driver beyond the caravan or other vehicle being towed. Towing vehicles may be a two wheel drive vehicle such as a sedan but in recent years with the advent of larger caravans and off-road destinations, the towing vehicle is typically a large four-wheel-drive vehicle such as a Toyota Landcruiser, Nissan Patrol, Ford F250 or the like and the caravan is typically significantly wider than the towing vehicle.

Historically, the caravanning public temporarily mounted towing mirrors to the driver side door of the towing vehicle for the journey to a holiday destination so that the driver could see following traffic and then removed them when the destination was reached so that the vehicle could be used at the destination or left them on if the vehicle was not needed. If the mirrors were removed upon reaching a desired destination, they had to be refitted for the return journey which might be some two or three weeks later. However, nowadays, people seem to holiday by way of continual travel so that the caravan might be unhitched for only one or two days in many cases and the towing vehicle used for local sightseeing. Consequently, the temporary towing mirrors had to be removed and replaced much more often and consequently the older style temporary towing mirrors are generally unsatisfactory. Moreover, nowadays there is considerably more traffic on the roads travelling at a greater speed than in earlier years and towing mirrors need to be more stable and more structurally sound.

In recent years, permanent towing mirrors have been developed which allow the mirror to be easily moved from a non-towing position to a towing position and vice versa. However, while such mirrors provide easier movement of the mirror, they sometimes do not meet the requirements of government authorities.

In that respect, Government authorities in some countries specify the maximum extent of a towing mirror beyond the cabin of the towing vehicle for the case when the vehicle is not towing and when it is towing. For example, the maximum extent of the mirror beyond the widest part of the cabin might be 150 mm when the vehicle is not towing anything and 390 mm when the vehicle is towing a caravan which might be necessary in order to give the driver vision beyond the caravan being towed. However, the permanent towing mirrors which are presently available do not meet the specifications and provide the necessary vision.

Modern external vehicle mirrors typically incorporate one or more electric motors within the mirror housing for the purpose of adjusting the mirror angle. Typically, mirrors need to be tilted up and down as well as in and out, that is, towards the vehicle and away from the vehicle. The electric motors and the linkage as well as the housing itself has a significant weight which puts an undesirably high load on the door to which the mirror is mounted. In the case of towing mirrors, the load is significantly higher than an ordinary vehicle mirror because the mirror and its housing is spaced further from the door which increases the moment on the door thus making the mirror more susceptible to vibration which in turn diminishes the quality of the view in the mirror.

In this specification, the term “permanent towing mirror” is to be understood as referring to a towing mirror which is movable from a non-towing position to a towing position even though it may be removed entirely from the vehicle and replaced by the vehicle's own factory mirror when the vehicle is no longer being used to tow a caravan or the like.

The present invention is aimed at providing permanent towing mirrors which are adjustable from a non-towing (or stowed) position in which the mirror is closer to the vehicle cabin and a towing (or extended) position in which the mirror provides a more desirable quality of the rearward view.

With the foregoing in view, the invention in one aspect resides broadly in a towing mirror including:

a mount adapted to be mounted to a vehicle cabin;

an extension component including a first member and a second member;

one of said first and second members including one or more tracks and the other including one or more carriages, said one or more tracks and said one or more carriages being arranged such that said one or more carriages run on said one or more tracks whereby said second member may move linearly relative to said first member from a retracted position to an extended position and vice versa; and

a mirror component operatively connected to said second member.

In another aspect, the invention resides broadly in a towing mirror including:

a mount adapted to be mounted to a vehicle cabin;

an extension component including a first member operatively connected at one end to said mount for pivoting movement relative thereto about a generally vertical axis and a second member;

one of said first and second members including one or more tracks and the other including one or more carriages, said one or more tracks and said one or more carriages being arranged such that said one or more carriages run on said one or more tracks whereby said second member may move linearly relative to said first member from a retracted position to an extended position and vice versa; and

a mirror component operatively connected to said second member for pivoting movement relative thereto about a generally horizontal axis extending substantially in the intended direction of travel of the vehicle cabin to which the mirror is to be mounted and spaced from said vertical axis.

In another aspect, the invention resides broadly in a towing mirror including:

a mount adapted to be mounted to a vehicle cabin;

an extension component including a first member or portion extending from said mount and a second member;

one of said first and second members including one or more tracks and the other including one or more carriages, said one or more tracks and said one or more carriages being arranged such that said one or more carriages run on said one or more tracks whereby said second member may move linearly relative to said first member from a retracted position to an extended position and vice versa; and

a mirror component operatively connected to said second member for pivoting movement relative thereto about a generally horizontal axis extending substantially in the intended direction of travel of the vehicle cabin to which the mirror is to be mounted and spaced from said vertical axis.

In one preferred form, the second member is arranged to travel longitudinally relative to the first member or portion to thereby move from a retracted position to an extended position. In such form, it is preferred that the first member or portion and the second member be constructed so as to incorporate keying means which prevent the second member rotating relative to the first member or portion through an arc about the longitudinal axis of the first member or portion. In one preferred form, the first member or portion and the second member have complementary noncircular cross-sectional shapes such as rectangular or part rectangular whereby one can travel relative to the other without any relative rotational movement. In that respect, it is preferred that said one or more tracks and said one or more carriages are arranged so that the carriages are restrained against movement in any direction other than a linear direction towards and away from the vehicle cabin.

Preferably, said one or more carriages and/or said one or more tracks include mobility assistance means such as wheels, rollers, balls, bearings or the like and/or friction reduction means such as low friction sleds or runners. In a particularly preferred form, the mobility means includes a plurality of wheels.

Preferably, said one or more carriages and/or said one or more tracks includes stabilisation means for stabilising said one or more carriages on said one or more tracks.

Preferably, said mobility assistance means and/or said friction reduction means incorporates said stabilisation means, whereby lateral movement of the second component relative to the first component is prevented or substantially inhibited in all directions except the intended linear movement direction between the retracted and extended positions so as to prevent chattering, or shuddering due to vibration arising from vehicle vibration or motion, wind or passing vehicle movement. In that respect, it will be appreciated that a driver's rear view can be detrimentally affected by mirror chattering.

In one preferred form, said stabilisation means includes biasing means for biasing the carriage in a predetermined direction. In one such form, said one or more carriages run between two sets of tracks and said biasing means bias said carriages into engagement with said two sets of tracks thereby stabilising the carriage between said sets of tracks. In one such form, one set of tracks includes two spaced apart tracks provided on converging inclined planes and the other set includes two spaced apart tracks provided on the vertical plane. However, both sets of tracks could be provided on converging inclined planes if desired. In a preferred form, the converging inclined planes are orthogonal and at 45 degrees to the vertical, the planes converging away from the other set of tracks.

In a particularly preferred form, one set of tracks is provided on the vertical plane and one set of tracks is provided on converging inclined planes, such planes converging away from the vertical plane. In such form it is preferred that the inclined planes are orthogonal and at 45 degrees to the vertical. Advantageously, such arrangement results in the inclined planes stabilising the one or more carriages in the horizontal direction and the vertical direction. Also, in such form it is preferred that the biasing means bias the one or more carriages towards the tracks provided on the inclined plane. In one such form, the biasing is achieved by applying a biasing force to the mobility assistance means whereby they are biased towards engagement with the vertical tracks thereby pushing the one or more carriages into engagement with the inclined planes.

In still another preferred form, a third set of tracks is provided on said one or more carriages to constrain movement in the vertical direction, that is, to constrain up-and-down movement of the second member relative to the first member. In such form, it is preferred that the third set of tracks include a lower track on which the one or more carriages run under the influence of gravity and an upper track arrange to prevent tilting of the second member relative to the first member while allowing linear travel of the second member relative to the first member.

Preferably, said one or more carriages include stop means for stopping linear movement of at least one of said one or more carriages relative to said one or more tracks. Preferably, said stop means includes a stop member mounted to one of said first and second members and a complementary recess in the other of said first and second members, said stop member being adapted to engage at least partially in said recess to selectively inhibit or stop said linear movement. In a preferred form, said stop member includes a wheel or roller adapted to engage said recess. In one such preferred form, said wheel or roller is biased towards the engaged position whereby it is urged into the recess at the desired limit of linear movement. It is also preferred that two spaced apart recesses be provided, one at the limit of selected travel in one direction and the other at the limit of selected travel in the opposite direction. It is also preferred that the recesses be provided in the member containing the tracks and between the tracks and the stop member be provided on the carriage.

Preferably, said second member includes a housing having an opening adapted to receive therethrough at least a portion of said first member, wherein said one set of tracks is provided on a first inner face of said housing and said one or more carriages is provided on said at least a portion of said first member. In such form, it is also preferred that a set of two spaced apart orthogonal inclined second tracks are provided on another or other faces spaced from and generally opposite (although inclined relative to) said first inner face and that said first member includes at least one carriage, said at least one carriage including first mobility assistance means arrange to run on said one set of tracks and second mobility assistance means arranged to run on said second set of tracks.

Advantageously, in such form, said biasing means are arranged to bias the mobility assistance means into engagement with the respective first tracks and second tracks so that said first member is constrained to engage said one set of tracks and said second set of tracks at the same time thereby inhibiting lateral movement of the first member relative to the second member. In such form, it is preferred that a third set of tracks be provided, one track being on a third inner face of the housing generally orthogonal to the first inner face and an opposing track on a fourth inner face opposite the third inner face and parallel thereto. Similarly, in such form, it is preferred that third and fourth mobility assistance means be provided to run on the third and fourth inner faces respectively.

In such form of the invention, it is also preferred that said stop recesses be provided in said first inner face.

In such form of the invention, it is preferred that the housing be made in at least two components for ease of assembly and that said one set of tracks provided on said first inner face of said housing is in a first component and said two spaced apart orthogonal inclined second tracks are provided in a complementary second component adapted to be secured to said first component. In such form, it is preferred that the first member be fitted to the first component of the housing with the one or more carriages resting in the first component and the first mobility assistance means being arranged on said one set of tracks and the second component of the housing then be fitted to the first component so as to lock the one or more carriages within the housing such that the second mobility assistance means runs on the second set of tracks. In such form, it is also preferred that the third and fourth mobility assistance means be arranged to run on opposed inner faces of the second housing component orthogonal to the first inner face.

Preferably, said mirror component is operatively connected to said second member for pivoting movement relative thereto about a generally horizontal axis extending substantially in the intended direction of travel of the vehicle cabin to which the mirror is to be mounted. In such form of the invention, it is particularly advantageous to include the third and fourth mobility assistance means to carry loads applied to the first component by the second component as the mirror component is being rotated or pivoted about a horizontal axis extending in the direction of travel from the non-towing position to the towing position. Advantageously, the third and fourth mobility assistance means are arranged to engage spaced apart horizontal faces so that they counteract or bear such applied loads.

Preferably, said extension component is mounted to said mount for pivoting movement relative thereto about a generally vertical axis which allows the extension component and the mirror component to be pivoted from a retracted position in which the extension component lies against the vehicle cabin to an operative position in which the extension component extends outwardly away from the vehicle cabin. It will be appreciated that the extension component is relatively short when in the retracted position and substantially longer when in the extended position and consequently significant loads will be applied to the third and fourth mobility assistance means.

Suitably, the extension component is relatively short when in the retracted position and substantially longer when in the extended position. Thus, when the extension component is retracted it does not extend as far outwards from the side of the vehicle cabin as it does when in the extended position. In a preferred form, the extension component in the extended position is approximately twice the length of the extension component in the retracted position.

Preferably the mirror component is substantially rectangular in form and is operatively connected to said second component for pivoting movement about a pivot axis adjacent one end whereby it can move through an arc of up to 180° or even a full circle such that in one position at least a substantial part of the mirror component can overlie said second member of the extension component and in another position is substantially beyond said second member. Accordingly, the pivoting of the mirror component provides further extension outward from the vehicle whereby the driver of the vehicle is afforded a view through the mirror further back than in either the retracted or overlying positions of the extension component and/or mirror component respectively. For convenience, the position at which the mirror component overlies the second component will be referred to as the overlying position and the position where the mirror component is pivoted substantially beyond the second component will be referred to as the outlying position.

In one such preferred form where the horizontal pivot axis is adjacent one corner of the mirror component, the mirror component moves through an arc of 90° with the result that the mirror component is substantially above and outside beyond the pivot axis. Advantageously, such arrangement optimises the extension of the mirror component laterally from the vehicle cabin and optimises the mount position on the cabin by being lower on the cabin wall where the wall is structurally stronger or at least has room for in wall reinforcing members.

Preferably the mirror component is mounted to the second member such that the mirror component is substantially rearward of the second member; that is to say, the second component is forward of the mirror component in the direction of vehicle travelling forward and does not interfere with the driver's vision in the mirror component. Moreover, such arrangement allows the first member in the second member to be constructed in a manner whereby they can be shaped to withstand wind forces without interfering with the driver's vision.

In yet another aspect, the invention resides broadly in a towing mirror including:

an extension component including a housing and a carriage, said housing forming a plurality of spaced apart tracks or having a plurality of spaced apart tracks therein and said carriage including mobility assistance means adapted to run on said tracks, at least some or said mobility assistance means being biased towards one track or one set of tracks so as to force other mobility assistance means into engagement with other tracks, said tracks and said carriage being arranged to substantially restrain said carriage against movement in a lateral direction. In such form of the invention, it is preferred that the various features and integers be as described herein.

In this specification, the terms “vertical” and “horizontal” have been used to differentiate two degrees of freedom or two general modes of movement and refer to the mirror in its position mounted to the cabin of a motor vehicle. However, those terms are intended only to express a general orientation to achieve rotational movement forwards and backwards in the general direction of travel and inwards and outwards away from the vehicle cabin and upwards and downwards to achieve rotational movement towards and away from the vehicle cabin and are not to be construed as limiting the invention to any particular orientation.

In order that the invention may be more clearly understood and put into practical effect, reference will now be made to the accompanying drawings wherein:

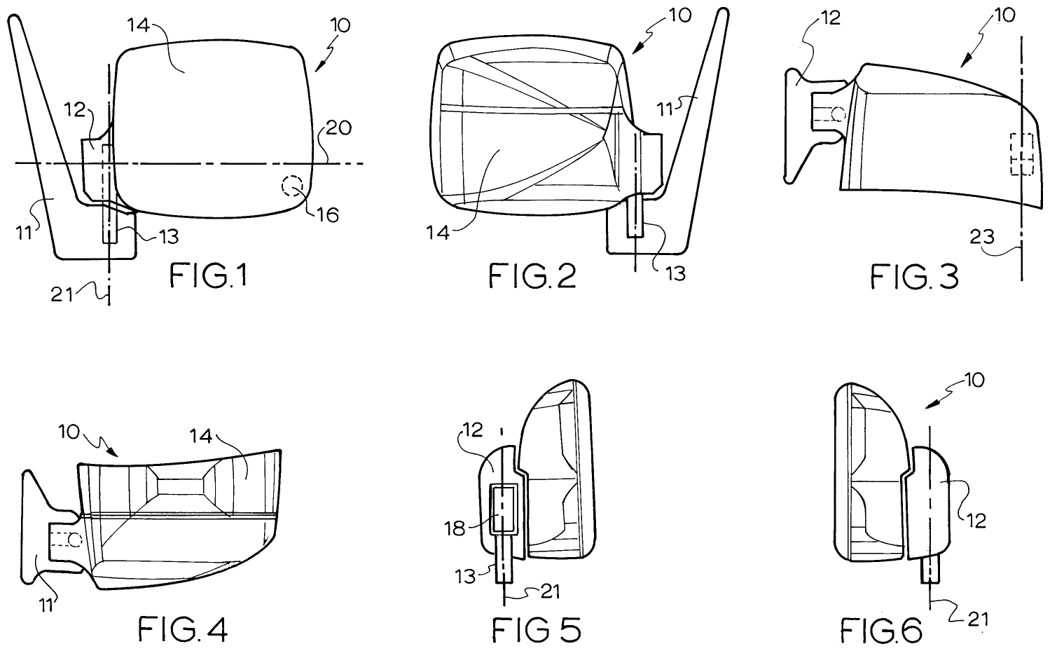

FIG. 1 is a front elevation of a towing mirror according to the applicants earlier invention described and illustrated in PCT/AU2017/051320 which is adapted to be mounted to the right-hand side of the vehicle and viewed from the rear of the vehicle on which it would be mounted in its fully retracted position;

FIG. 2 is a rear elevation of the towing mirror of FIG. 1 when viewed from the front of the vehicle;

FIG. 3 is a plan view of the towing mirror of FIG. 1 viewed from above;

FIG. 4 is a plan view of the towing mirror of FIG. 1 viewed from below;

FIG. 5 is a side elevation of the towing mirror of FIG. 1 viewed from the outside of the vehicle;

FIG. 6 is a side elevation of the towing mirror of FIG. 1 viewed from inside the vehicle;

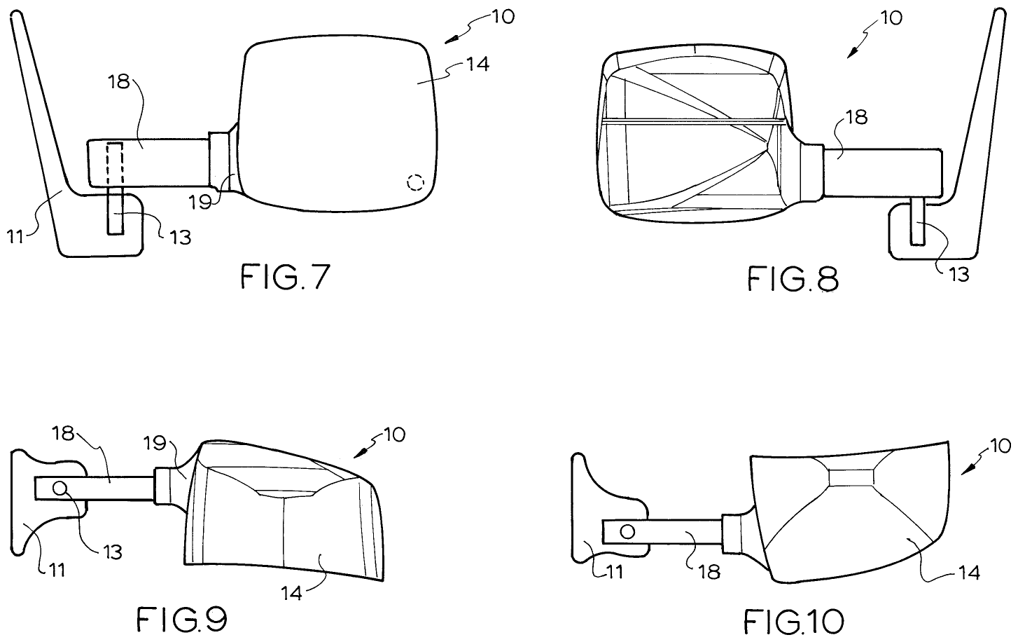

FIG. 7 is a front elevation of the towing mirror of FIG. 1 viewed from the rear of the vehicle on which it would be mounted in a part extended position;

FIG. 8 is a rear elevation of the towing mirror of FIG. 1 when viewed from the front of the vehicle in the position of FIG. 7;

FIG. 9 is a plan view of the towing mirror of FIG. 1 viewed from above in the position of FIG. 7;

FIG. 10 is a plan view of the towing mirror of FIG. 1 viewed from below in the position of FIG. 7;

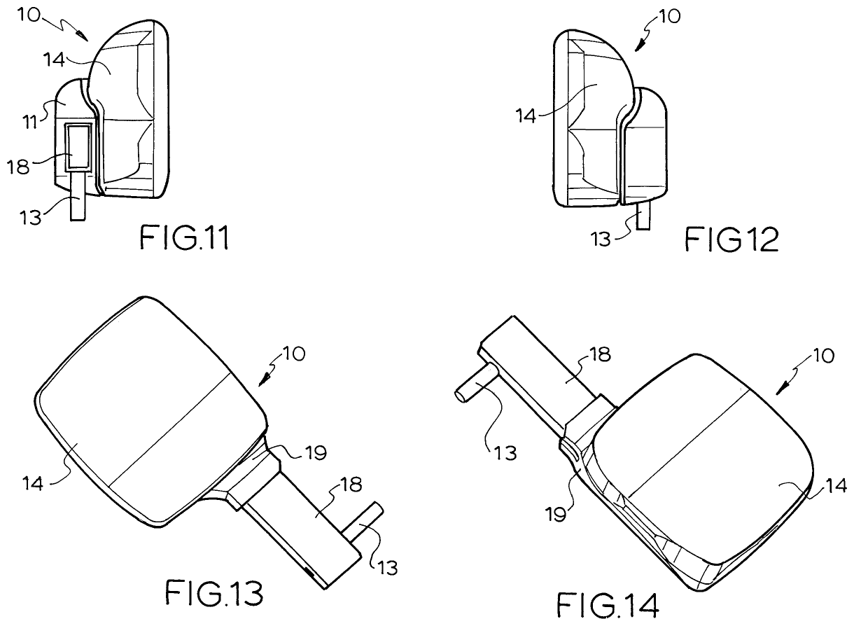

FIG. 11 is a side elevation of the towing mirror of FIG. 1 viewed from the outside of the vehicle in the position of FIG. 7;

FIG. 12 is a side elevation of the towing mirror of FIG. 1 viewed from inside the vehicle in the position of FIG. 7;

FIG. 13 is a pictorial representation of the towing mirror of FIG. 1 from one side in the position of FIG. 7 but removed from its mount;

FIG. 14 is a pictorial representation of the towing mirror of FIG. 1 from the other side in the position of FIG. 7 but removed from its mount;

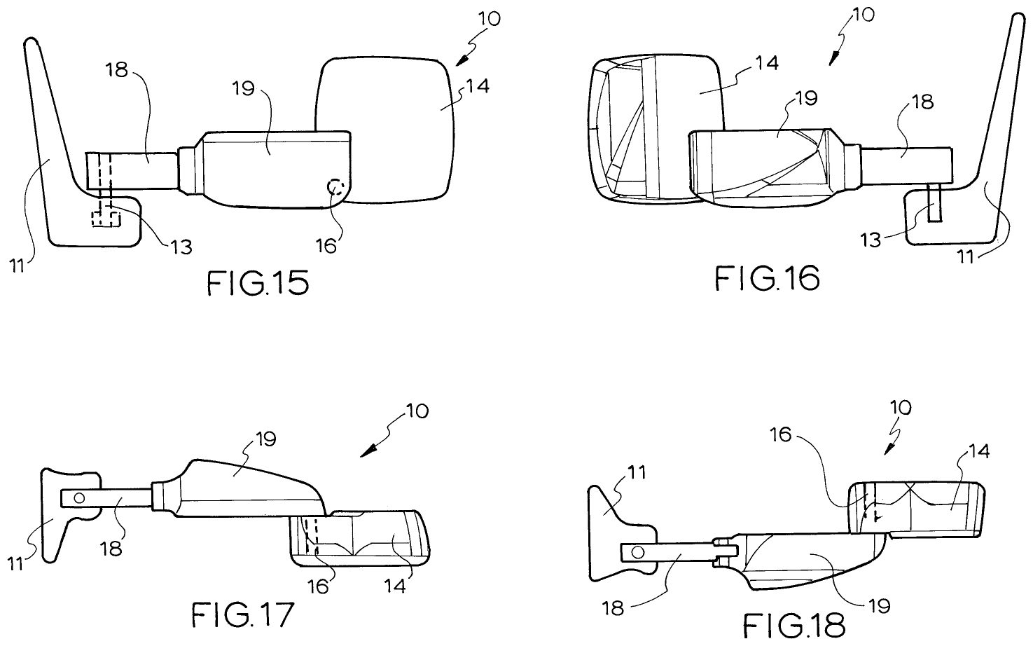

FIG. 15 is a front elevation of the towing mirror of FIG. 1 viewed from the rear of the vehicle on which it would be mounted in a fully extended position;

FIG. 16 is a rear elevation of the towing mirror of FIG. 1 when viewed from the front of the vehicle in the position of FIG. 15;

FIG. 17 is a plan view of the towing mirror of FIG. 1 viewed from above in the position of FIG. 15;

FIG. 18 is a plan view of the towing mirror of FIG. 1 viewed from below in the position of FIG. 15;

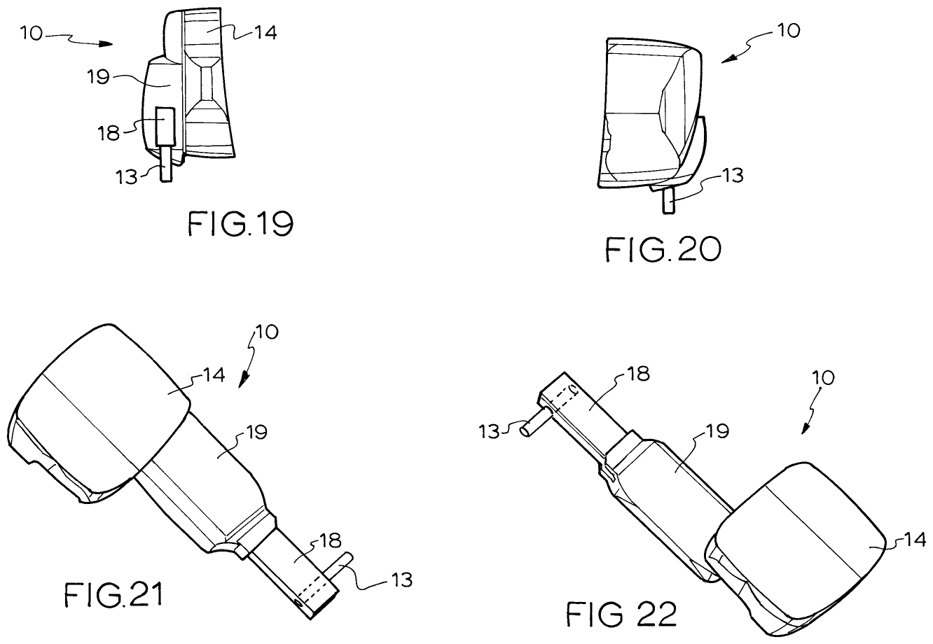

FIG. 19 is a side elevation of the towing mirror of FIG. 1 viewed from the outside of the vehicle in the position of FIG. 15;

FIG. 20 is a side elevation of the towing mirror of FIG. 1 viewed from inside the vehicle in the position of FIG. 15;

FIG. 21 is a pictorial representation of the towing mirror of FIG. 1 from one side in the position of FIG. 15 but removed from its mount;

FIG. 22 is a pictorial representation of the towing mirror of FIG. 1 from the other side in the position of FIG. 15 but removed from its mount;

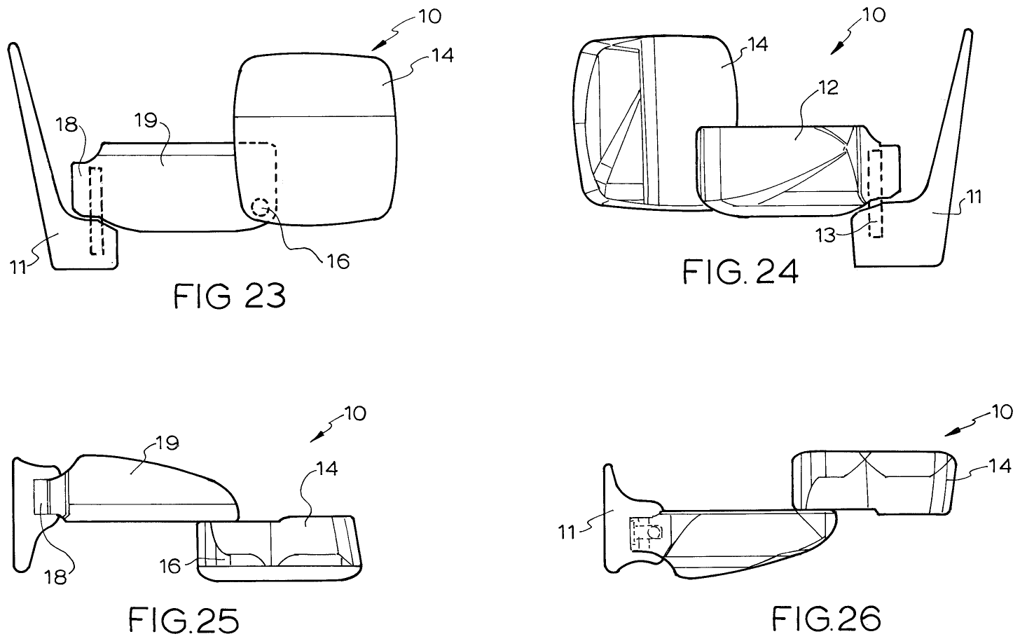

FIG. 23 is a front elevation of the towing mirror of FIG. 1 viewed from the rear of the vehicle on which it would be mounted in an alternative part extended position;

FIG. 24 is a rear elevation of the towing mirror of FIG. 1 when viewed from the front of the vehicle in the position of FIG. 23;

FIG. 25 is a plan view of the towing mirror of FIG. 1 viewed from above in the position of FIG. 23;

FIG. 26 is a plan view of the towing mirror of FIG. 1 viewed from below in the position of FIG. 23;

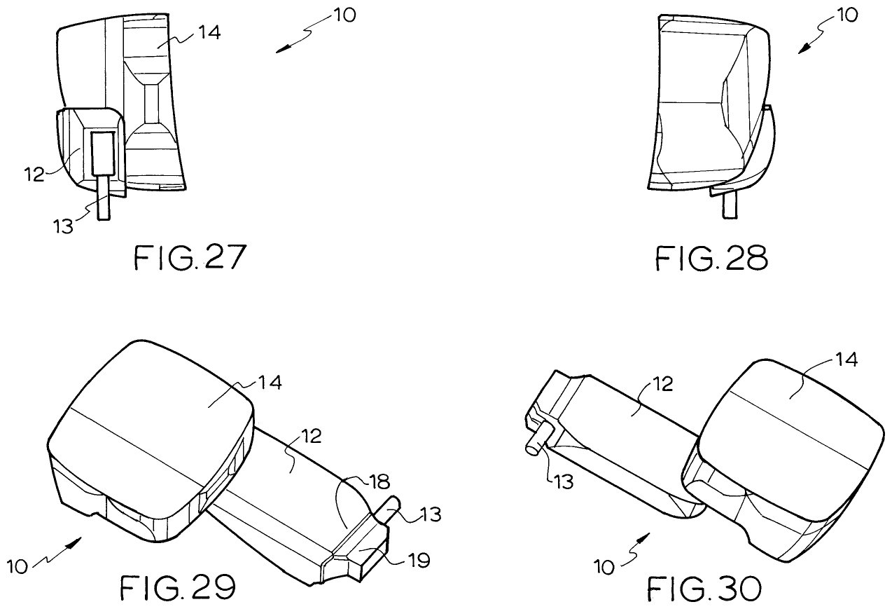

FIG. 27 is a side elevation of the towing mirror of FIG. 1 viewed from the outside of the vehicle in the position of FIG. 23;

FIG. 28 is a side elevation of the towing mirror of FIG. 1 viewed from inside the vehicle in the position of FIG. 23;

FIG. 29 is a pictorial representation of the towing mirror of FIG. 1 from one side in the position of FIG. 23 but removed from its mount;

FIG. 30 is a pictorial representation of the towing mirror of FIG. 1 from the other side in the position of FIG. 23 but removed from its mount;

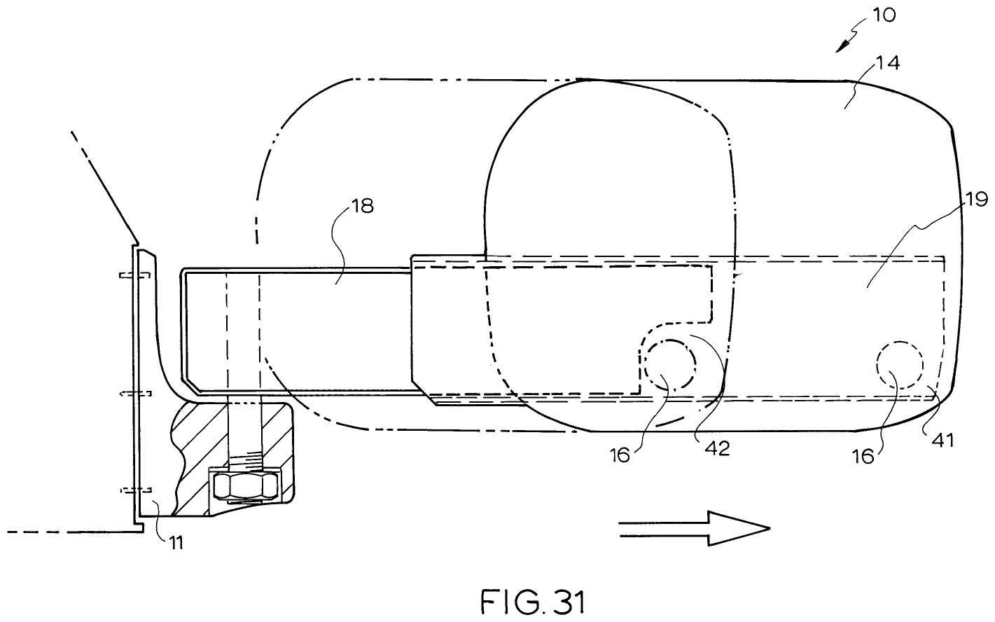

FIG. 31 is an enlarged schematic elevation of the towing mirror illustrated in FIG. 15 with a slightly different mirror component;

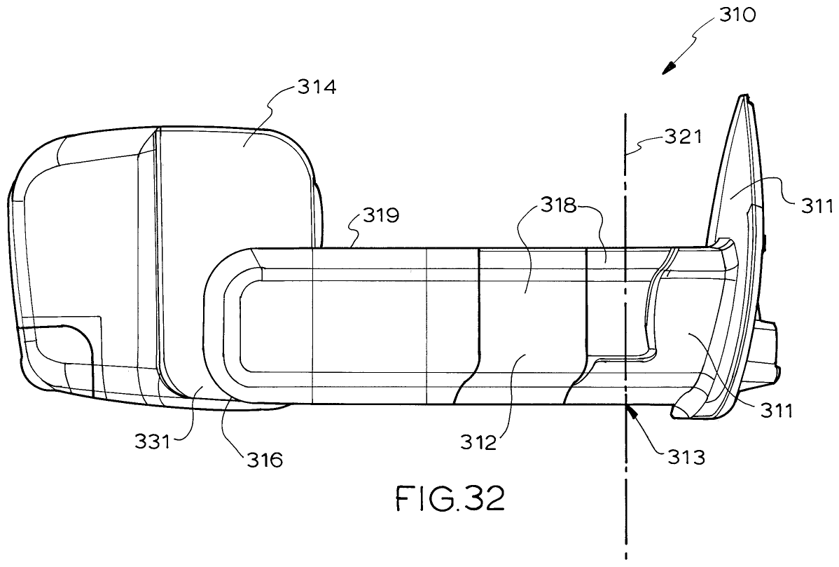

FIG. 32 is an elevation of a towing mirror according to the present invention which is adapted to be mounted on the right-hand side of a vehicle, FIG. 32 is viewed from the front of the vehicle with the mirror component fully extended to the same position as shown in FIGS. 15 to 19;

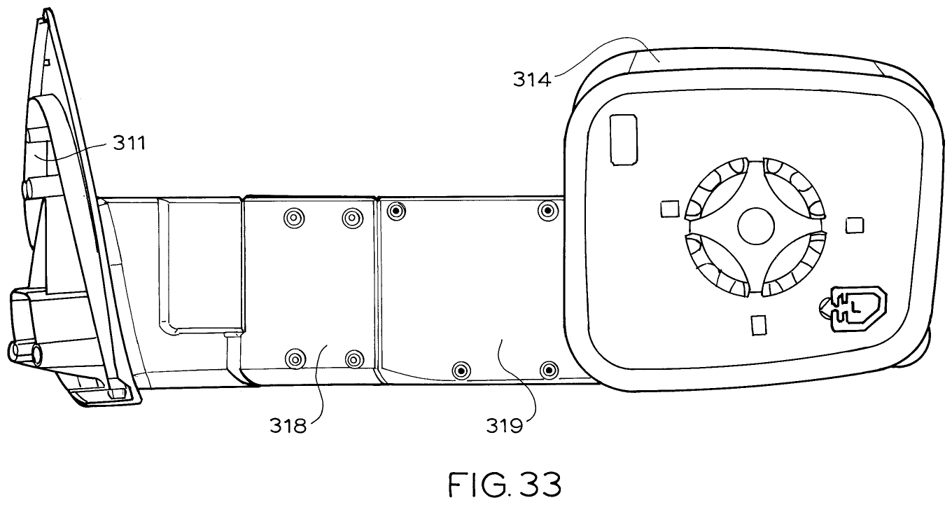

FIG. 33 is an elevation of the towing mirror of FIG. 32 in the same position as in FIG. 32 but viewed from the rear of the vehicle with some components behind the glass shown through the glass;

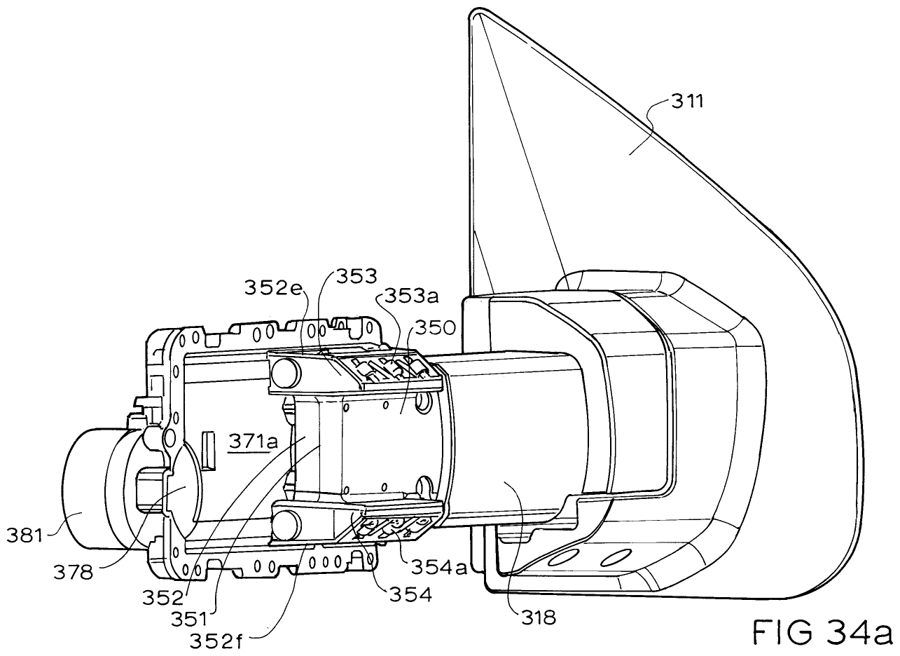

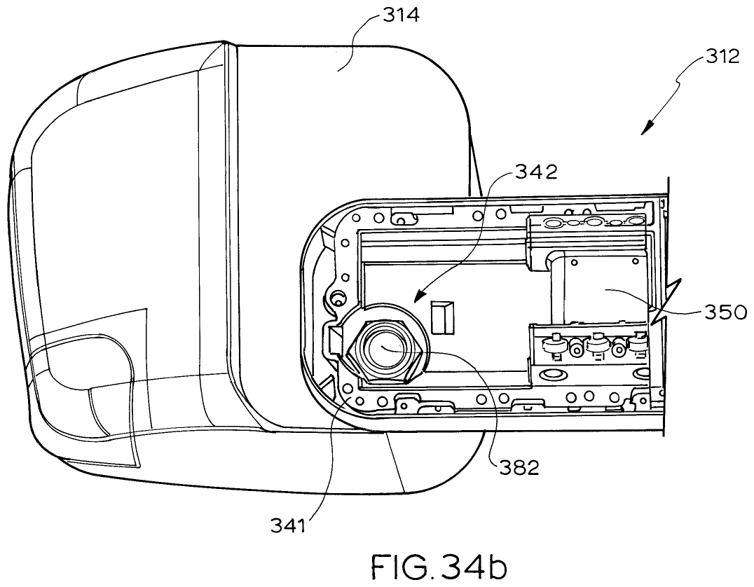

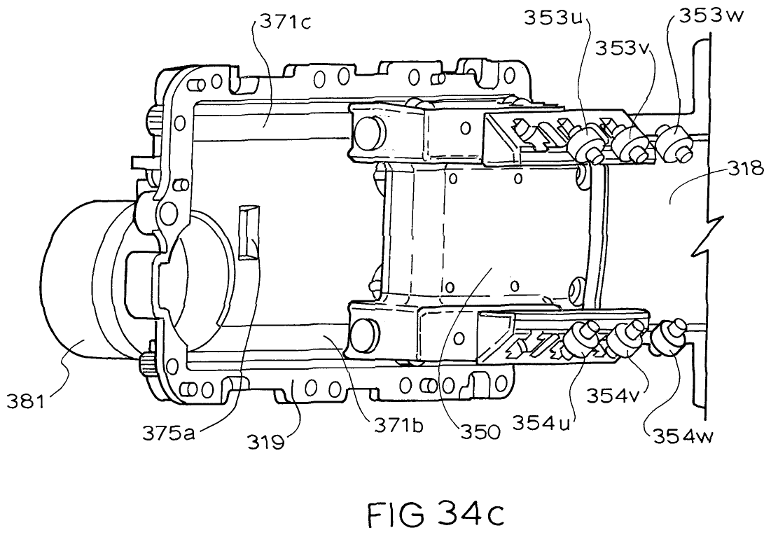

FIG. 34 is an elevation from the front of the vehicle of part of the towing mirror of FIG. 32 with various cover components removed and showing the carriage component of the first member engaged with the housing component of the second member;

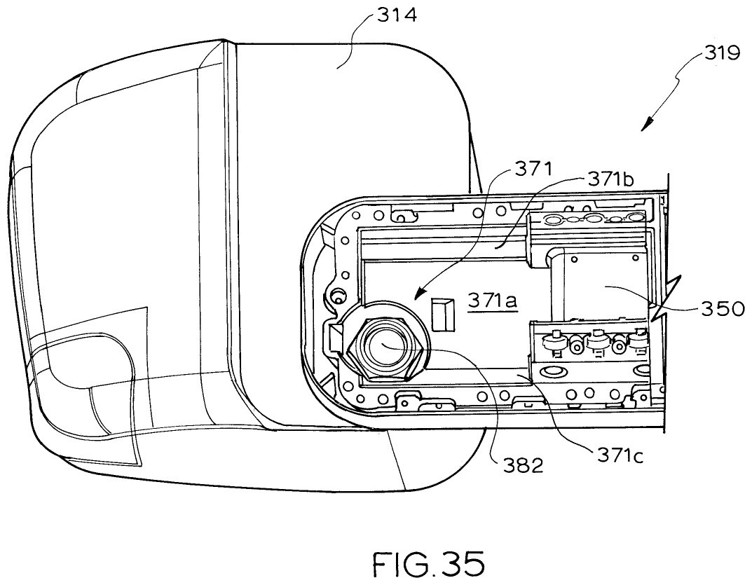

FIG. 35 is an elevation from the front of the vehicle of part of the towing mirror of FIG. 32 in a similar position to that shown in FIG. 34 but with one housing half removed to show the carriage component of the first member engaged with tracks in the other housing half of the second member;

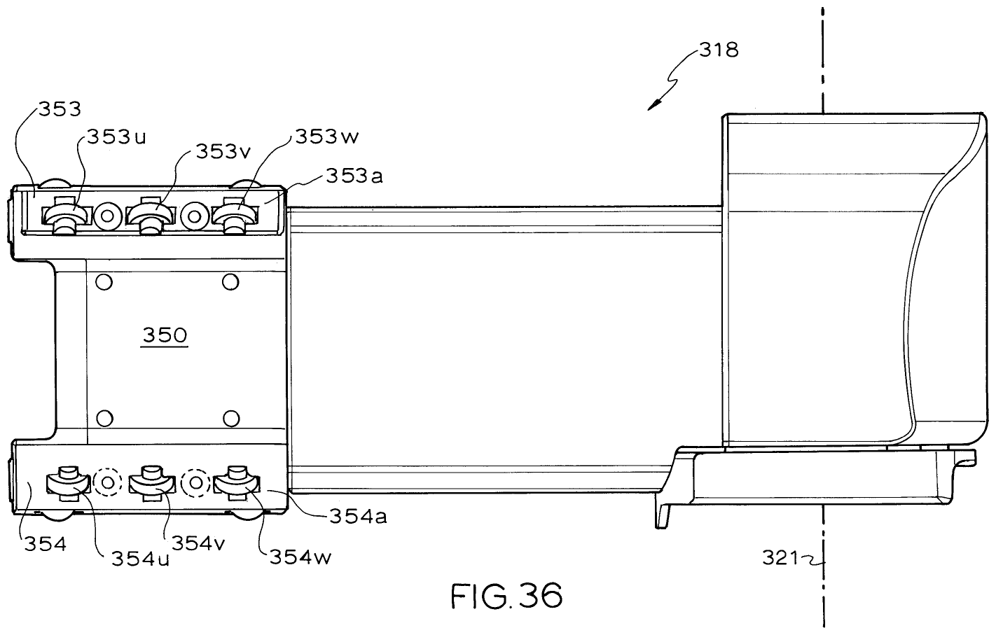

FIG. 36 is an elevation from the front of the vehicle of the first part of the towing mirror of FIG. 32;

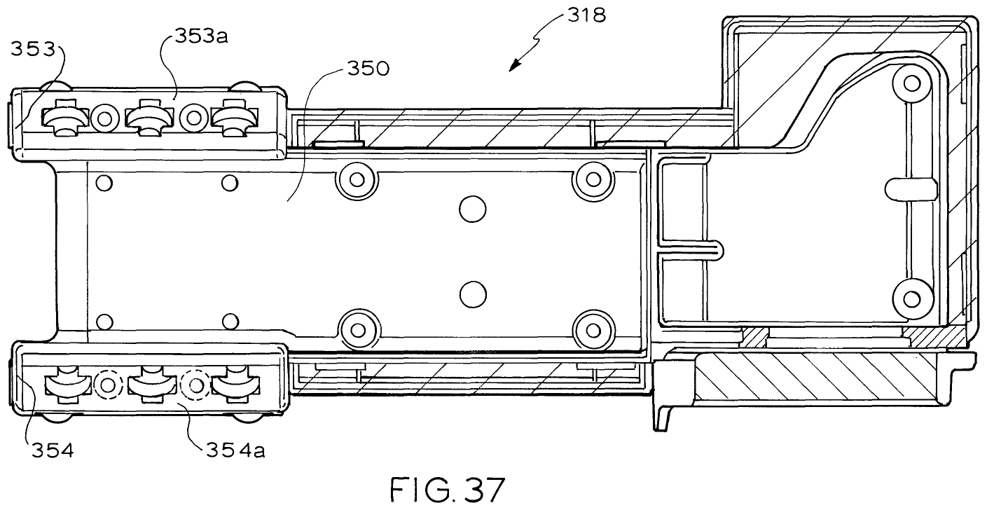

FIG. 37 is an elevation from the front of the first part of the towing mirror shown in FIG. 36 with the front cover components removed;

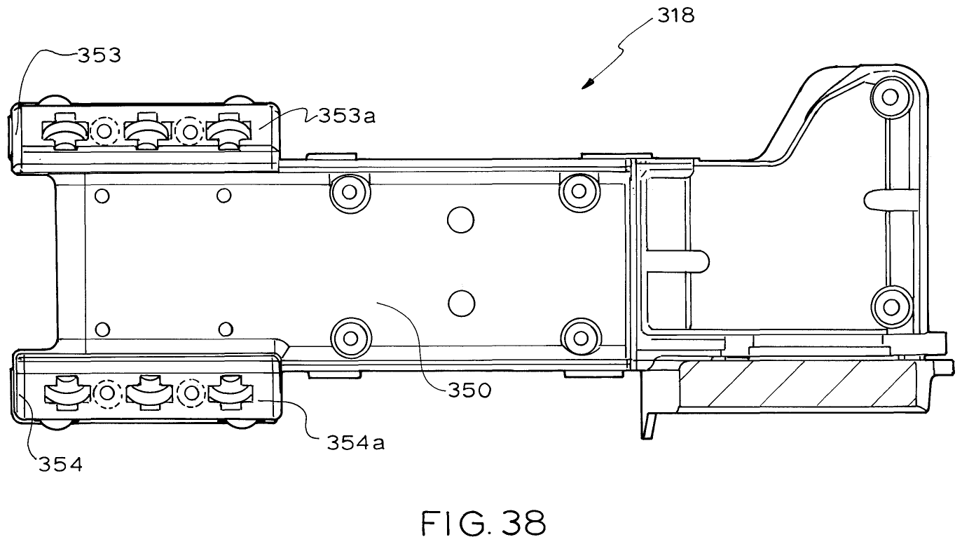

FIG. 38 is an elevation of the first part of the towing mirror shown in FIG. 36 from the front with front and rear cover components removed;

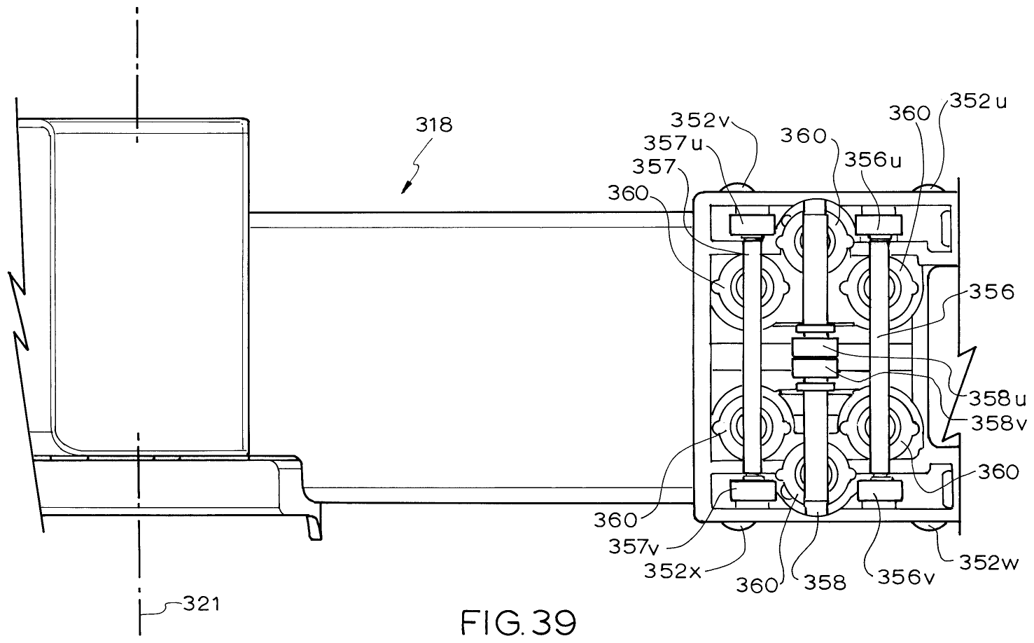

FIG. 39 is an elevation of the first part of the towing mirror of FIG. 32 and corresponding to FIG. 36 from the rear;

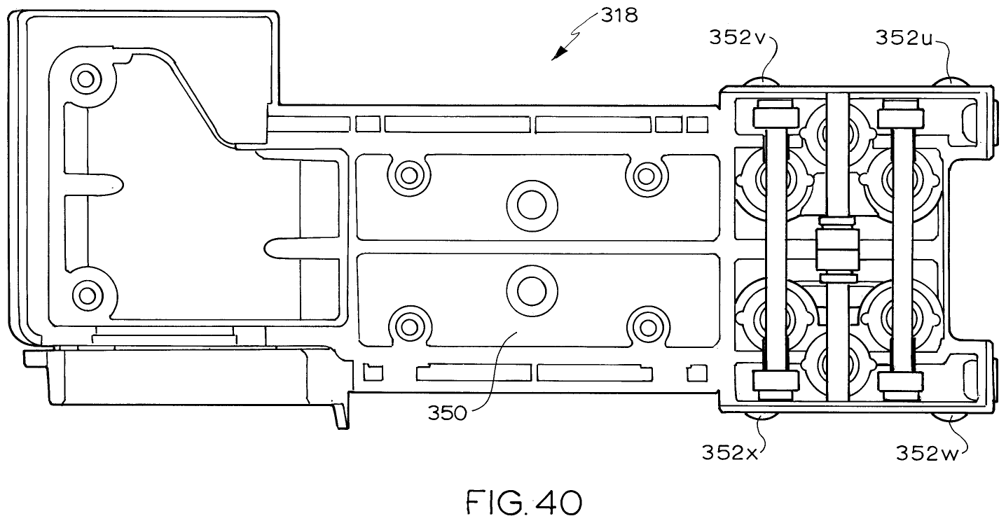

FIG. 40 is an elevation of the first part of the towing mirror shown in FIG. 37 from the rear with rear cover components removed;

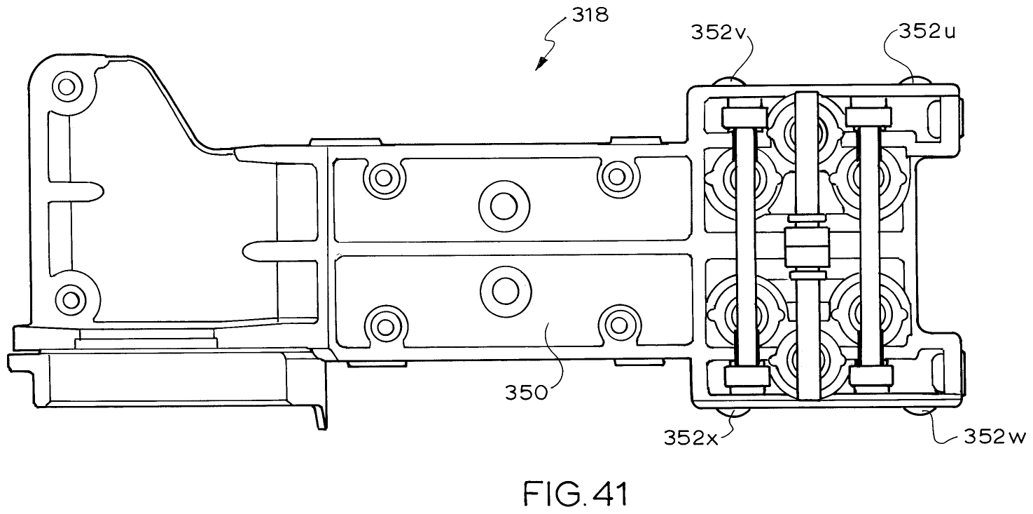

FIG. 41 is an elevation of the first part of the towing mirror shown in FIG. 37 from the rear with front and rear cover components removed;

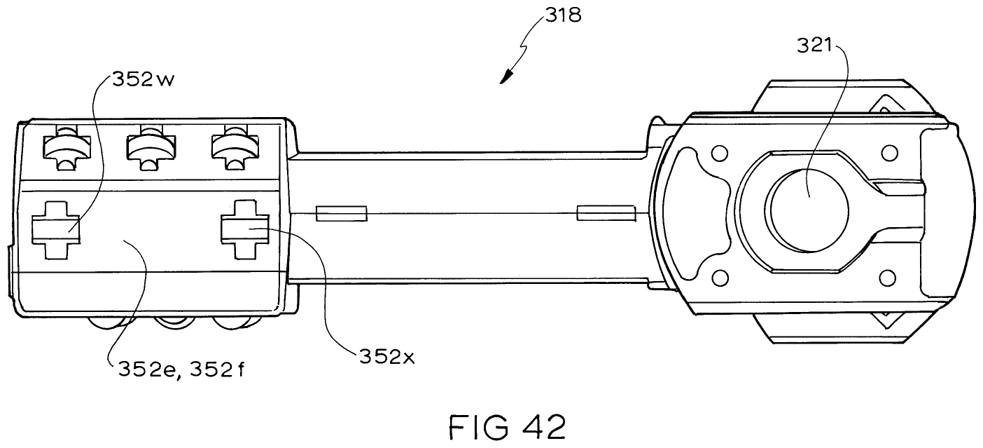

FIG. 42 is an underside plan view of the first part of the towing mirror shown in FIG. 32;

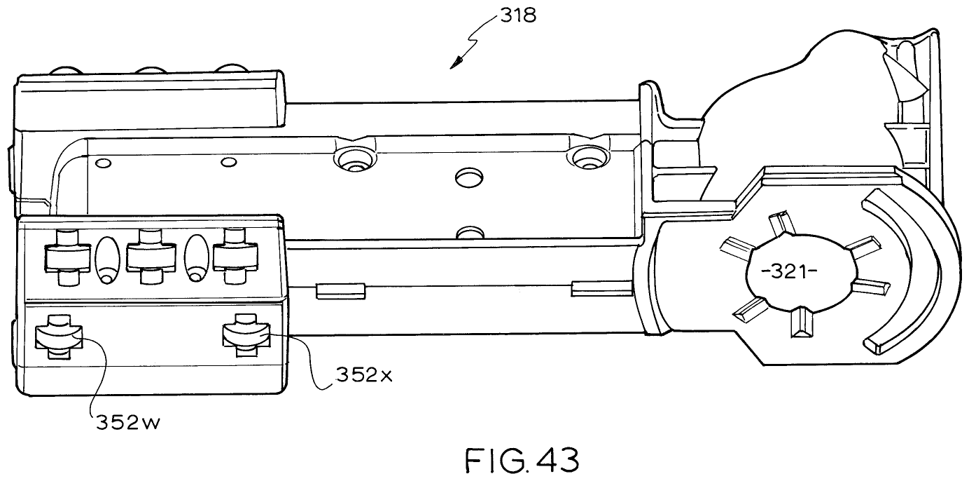

FIG. 43 is a pictorial representation of the carriage housing of the towing mirror of FIG. 32;

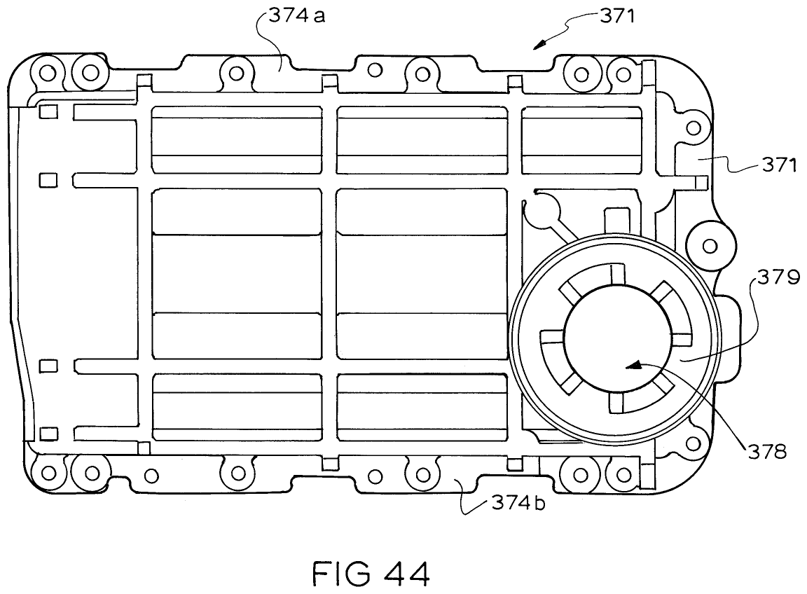

FIG. 44 is an elevation from the front of one half of the carriage housing of the towing mirror of FIG. 32 with cover components removed;

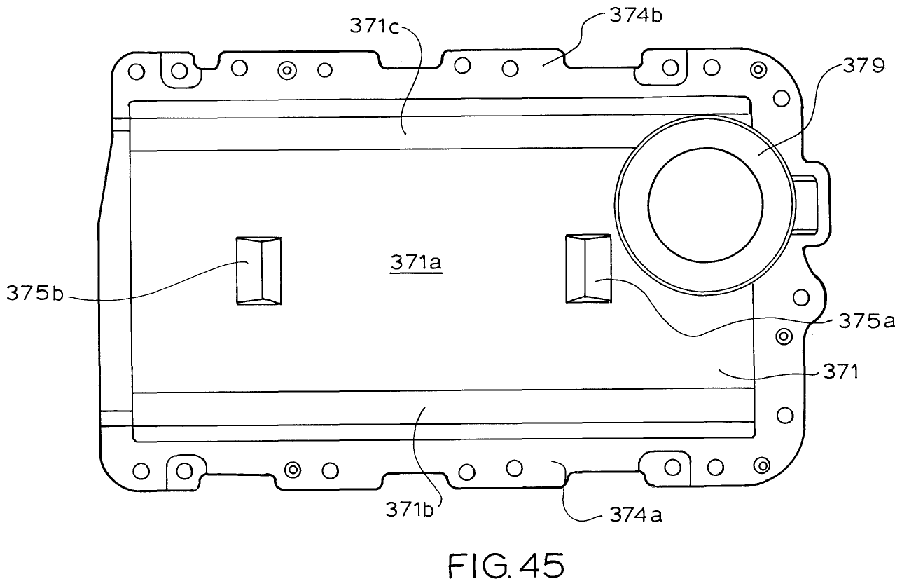

FIG. 45 is an elevation from the rear of the one half of the carriage housing shown in FIG. 44;

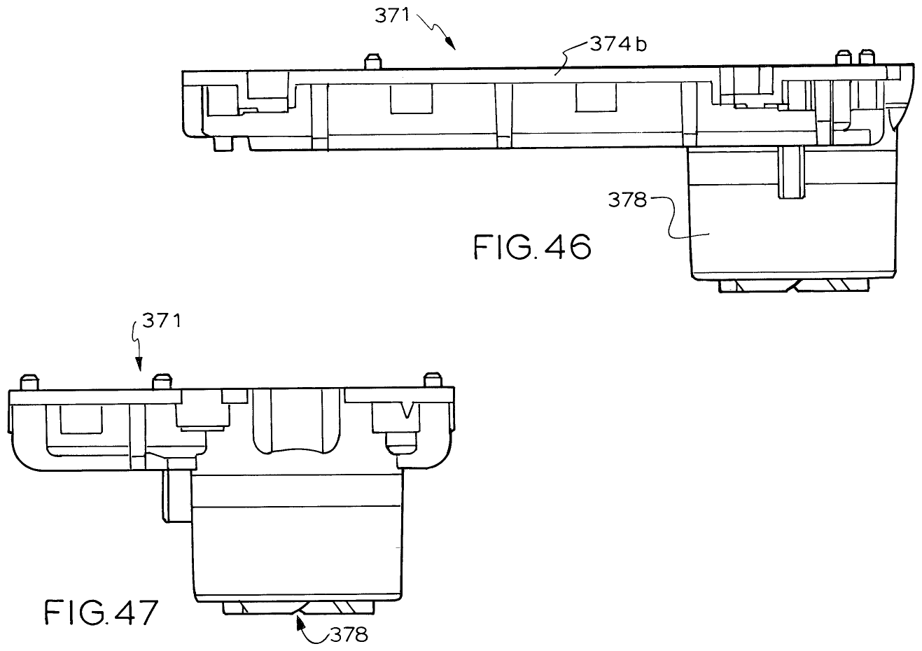

FIG. 46 is an underside plan view of the one half of the carriage housing shown in FIG. 44;

FIG. 47 is an end elevation of the one half of the carriage housing shown in FIG. 44;

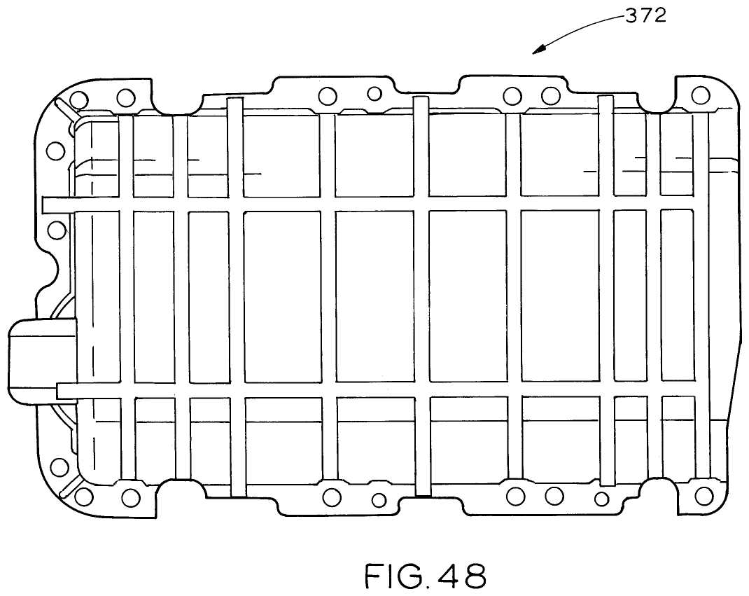

FIG. 48 is an elevation from the front of the other half of the carriage housing of the towing mirror of FIG. 32 with cover components removed;

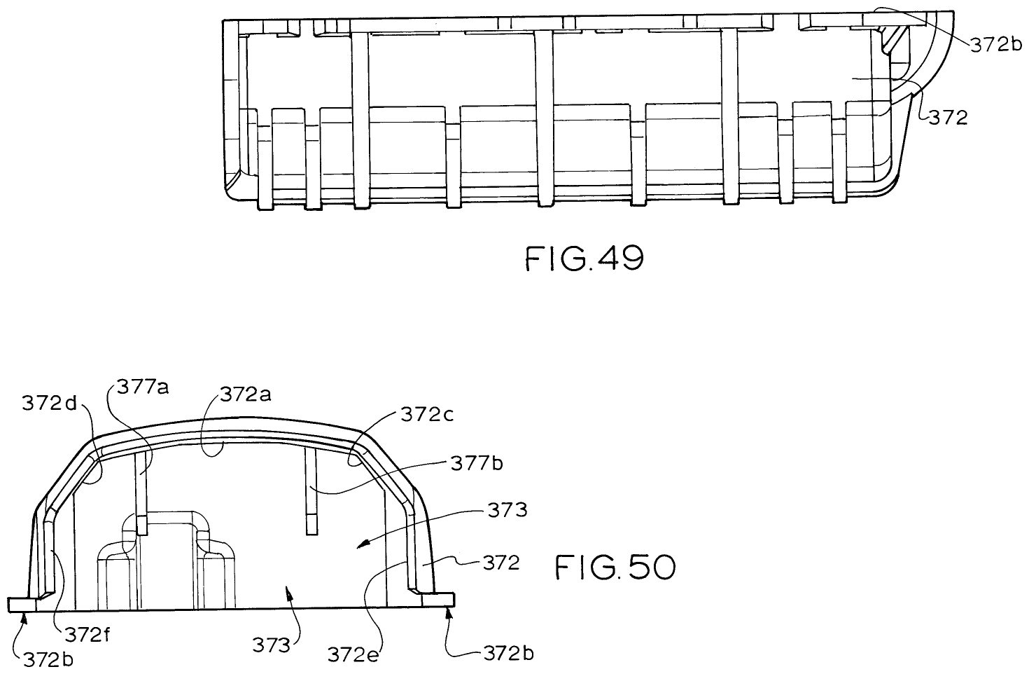

FIG. 49 is a plan view of the one half of the carriage housing shown in FIG. 48;

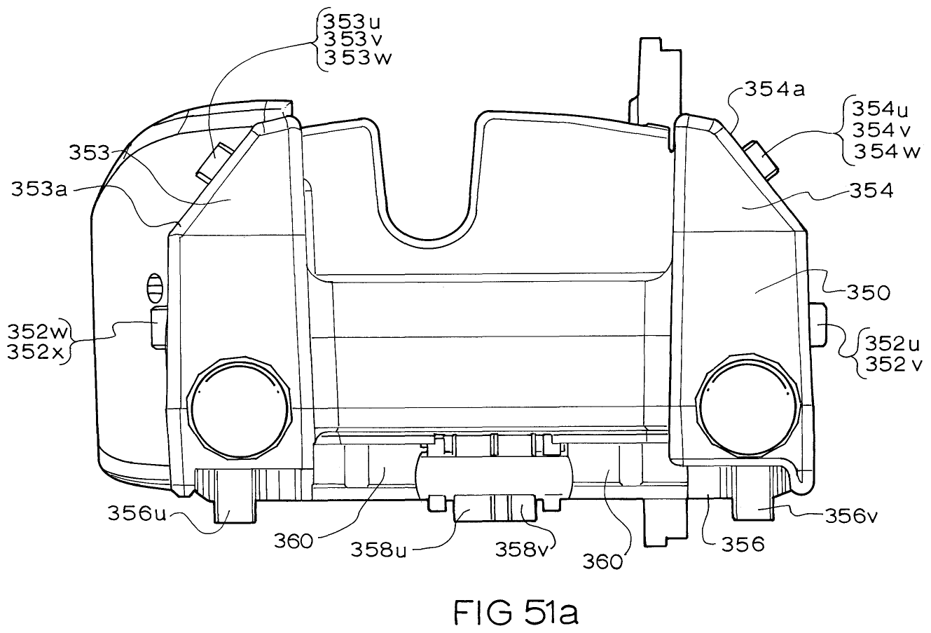

FIG. 50 is an end elevation of the one half of the carriage housing shown in FIG. 48;

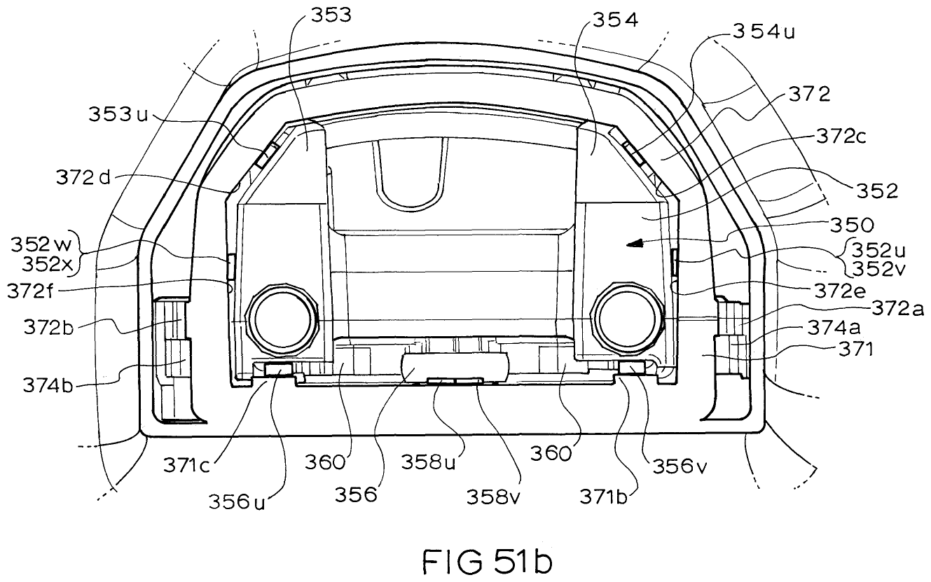

FIG. 51a is an end view of the carriage end of the first part of the towing mirror of FIG. 32; and

FIG. 51b is a sectional end view of the housing of the towing mirror of FIG. 32 with the carriage mounted therein.

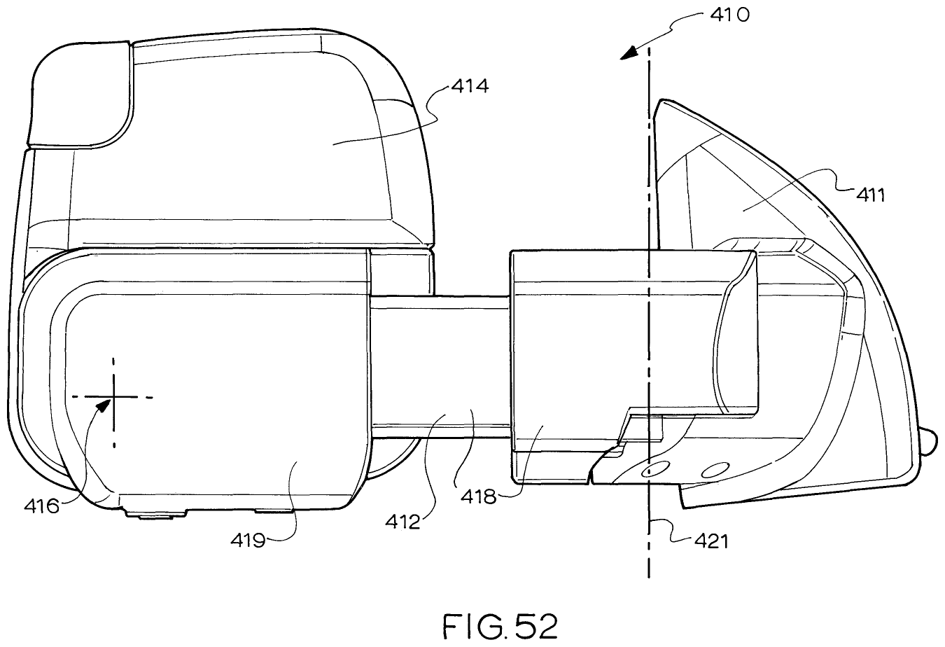

FIG. 52 is an elevation of another towing mirror according to the present invention viewed from the front of the vehicle and which is adapted to be mounted on the right-hand side of a vehicle;

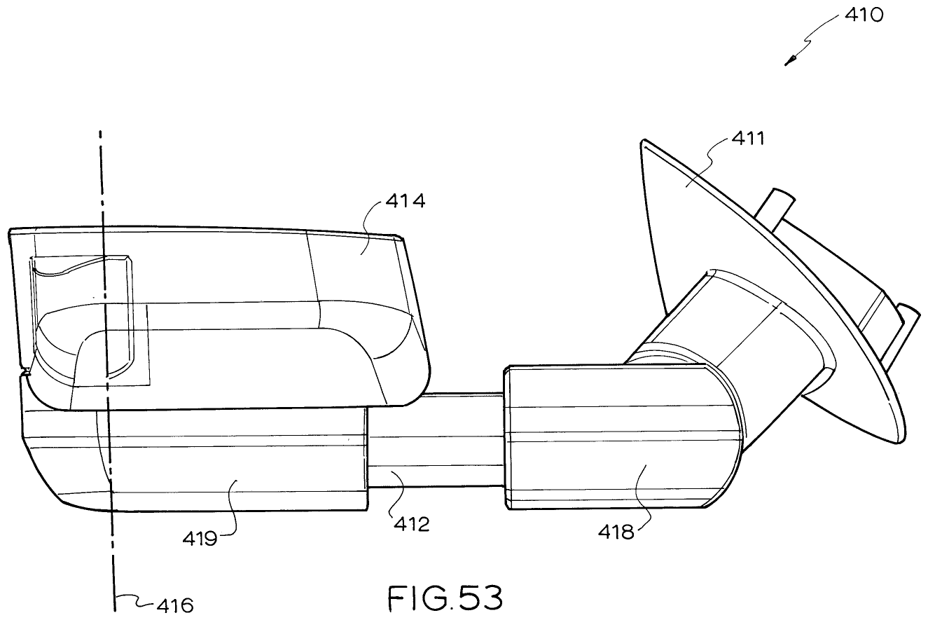

FIG. 53 is a top plan view of the towing mirror of FIG. 52;

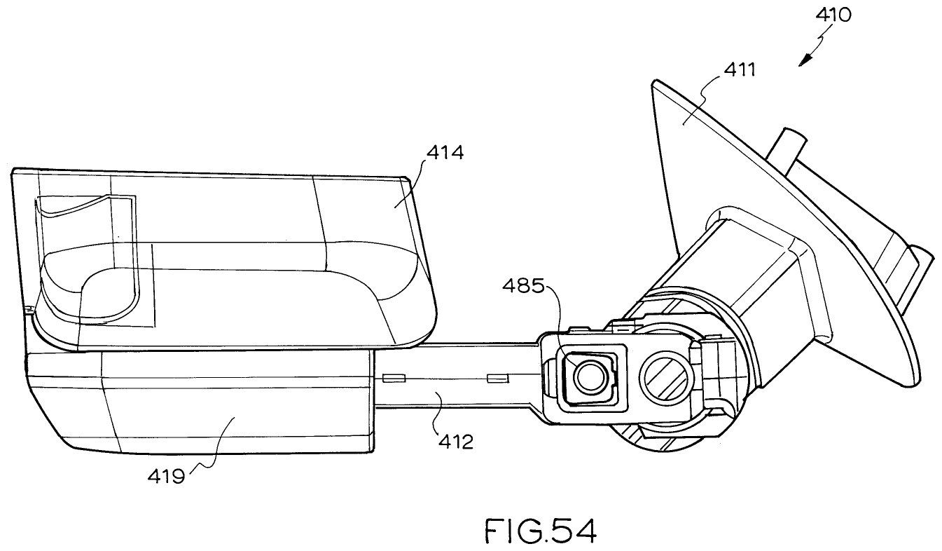

FIG. 54 is a top plan view of the mirror of FIG. 52 with some cover components removed and showing the motorised folding aspect;

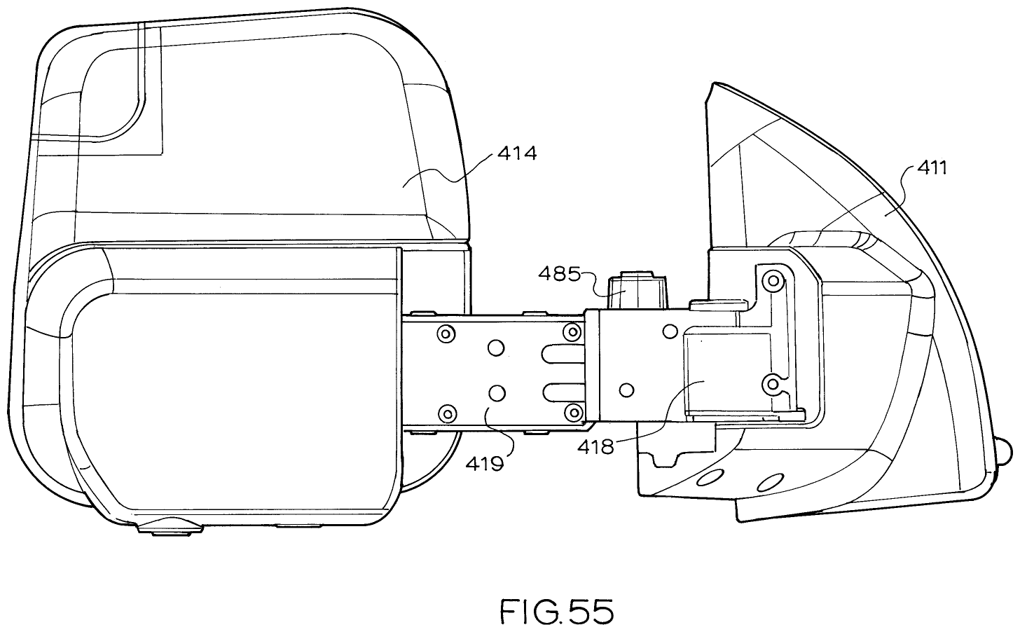

FIG. 55 is an elevation of the mirror of FIG. 52 from the front of the vehicle with the same cover components removed as in FIG. 54;

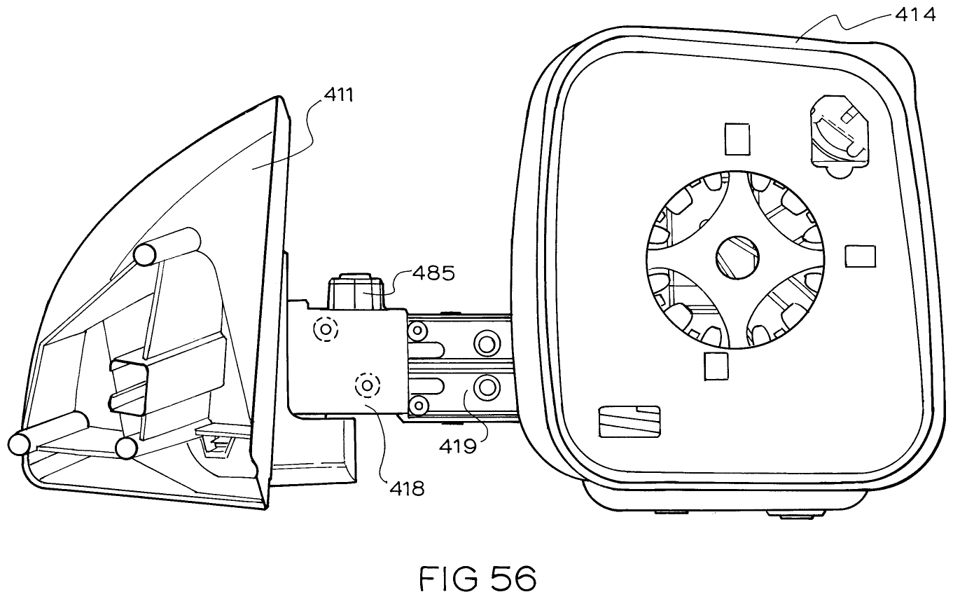

FIG. 56 is an elevation of the mirror of FIG. 52 with the same cover components removed as in FIG. 54 and with the mirror glass also removed;

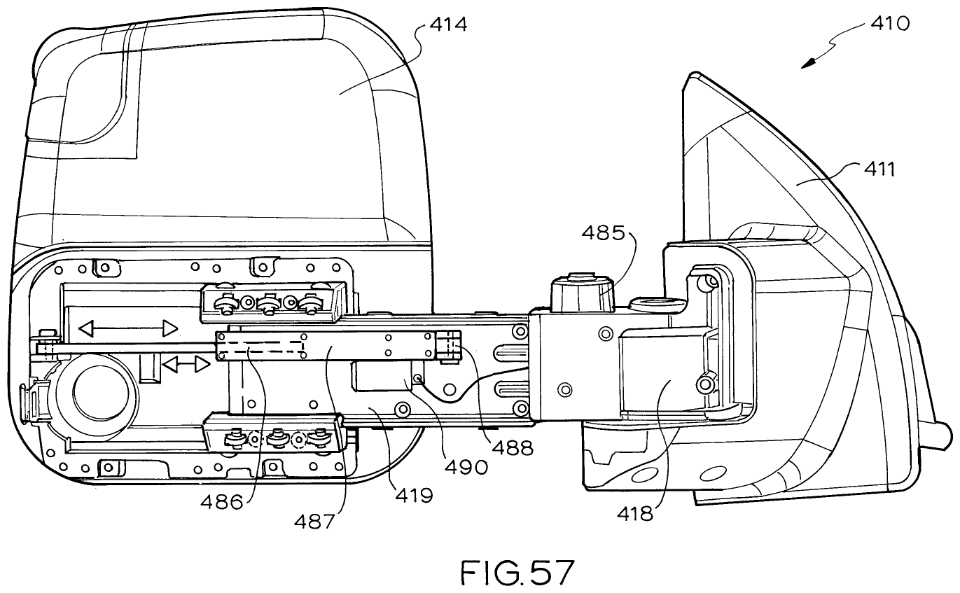

FIG. 57 is another elevation of the towing mirror of FIG. 52 viewed from the front of the vehicle showing detail of the extension component actuated by a linear actuator with the extension component extended;

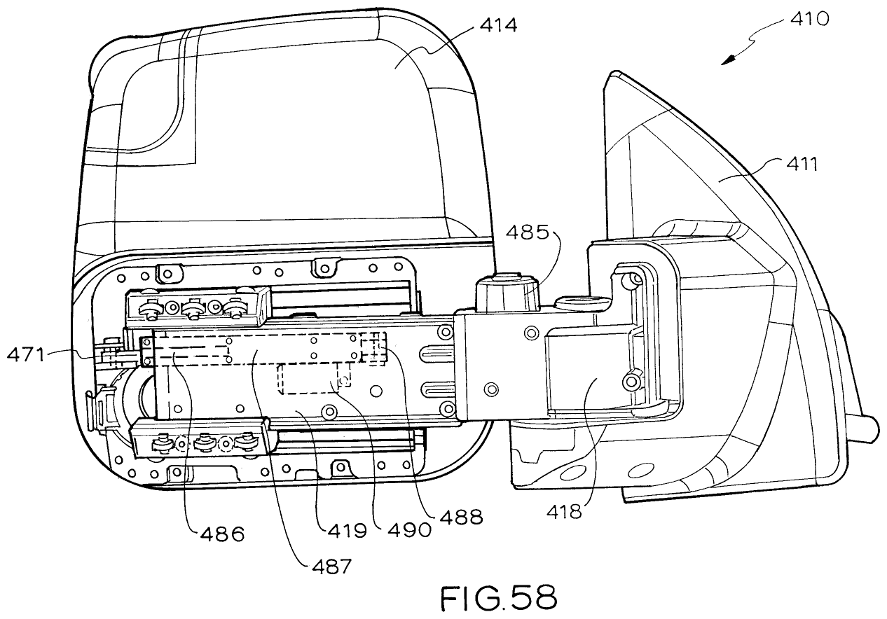

FIG. 58 is an elevation of the towing mirror of FIG. 57 viewed from the same position but with the extension component retracted;

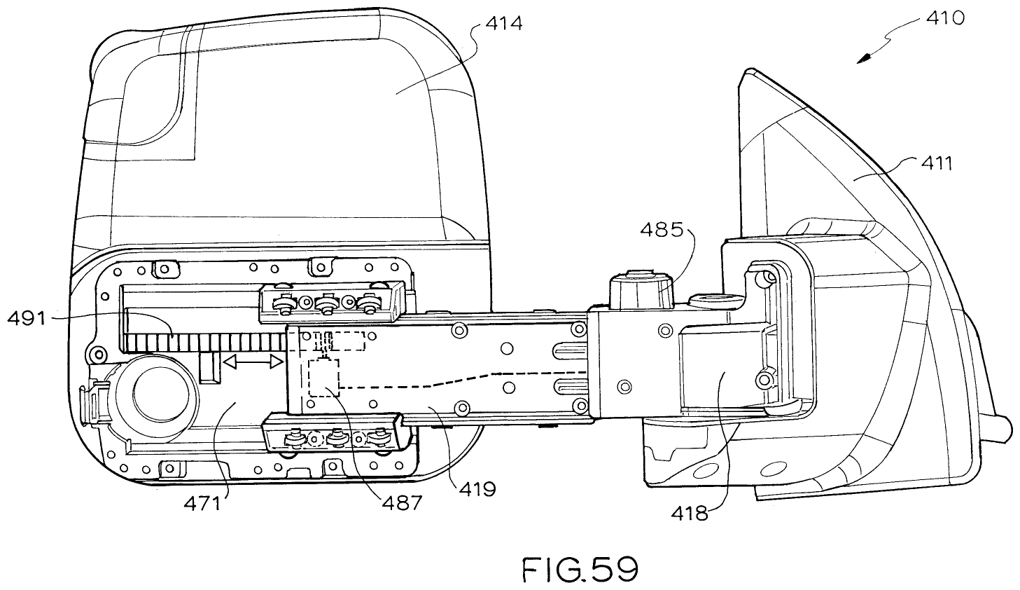

FIG. 59 is an elevation of the towing mirror of FIG. 52 viewed from the front of the vehicle showing the extension component actuated by a gear drive arrangement with the extension component extended;

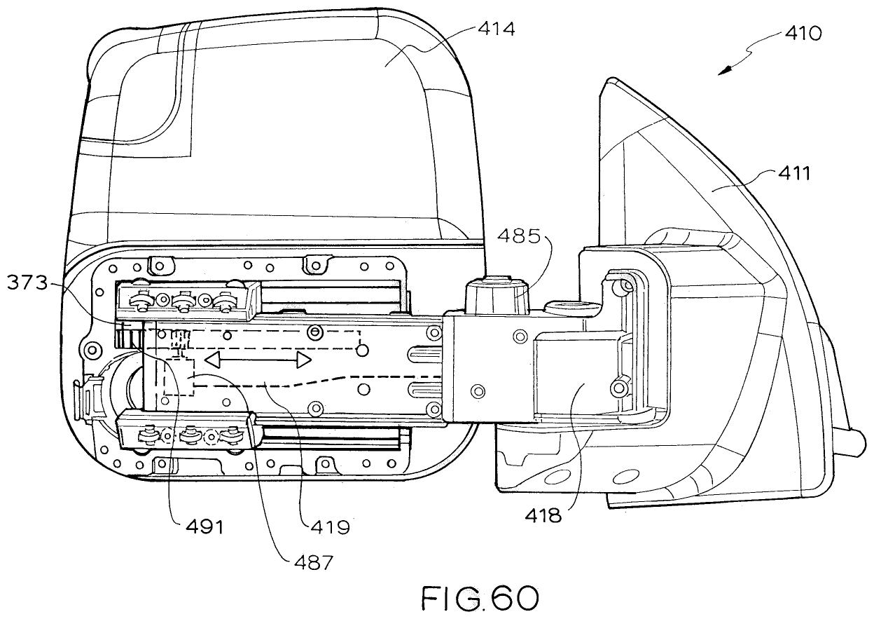

FIG. 60 is an elevation of the towing mirror of FIG. 59 viewed from the same position but with the extension component retracted;

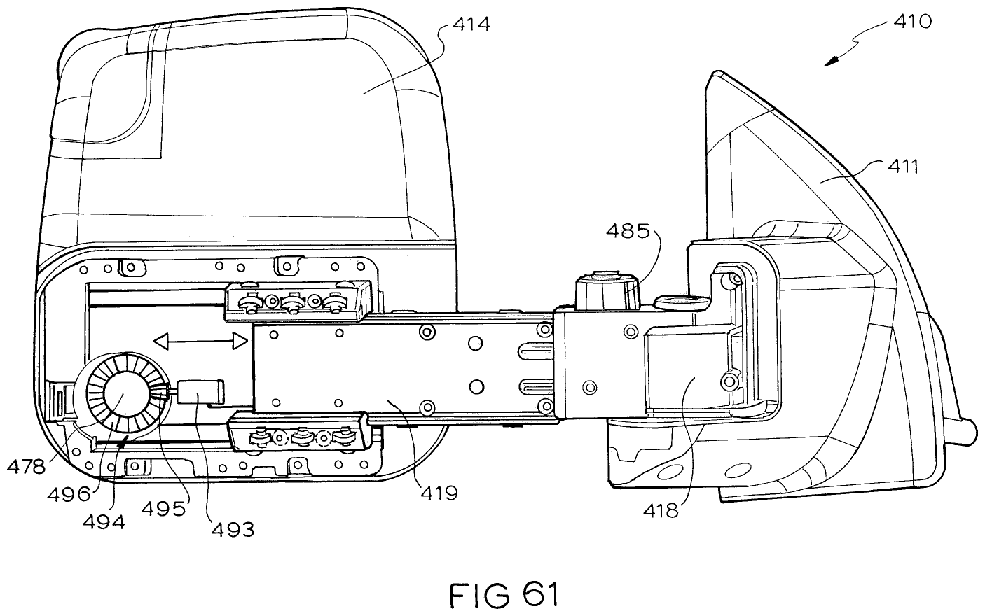

FIG. 61 is an elevation of the towing mirror of FIG. 52 viewed from the front of the vehicle with the extension component extended and the mirror component in the first or inner position and actuated by a gear drive mechanism;

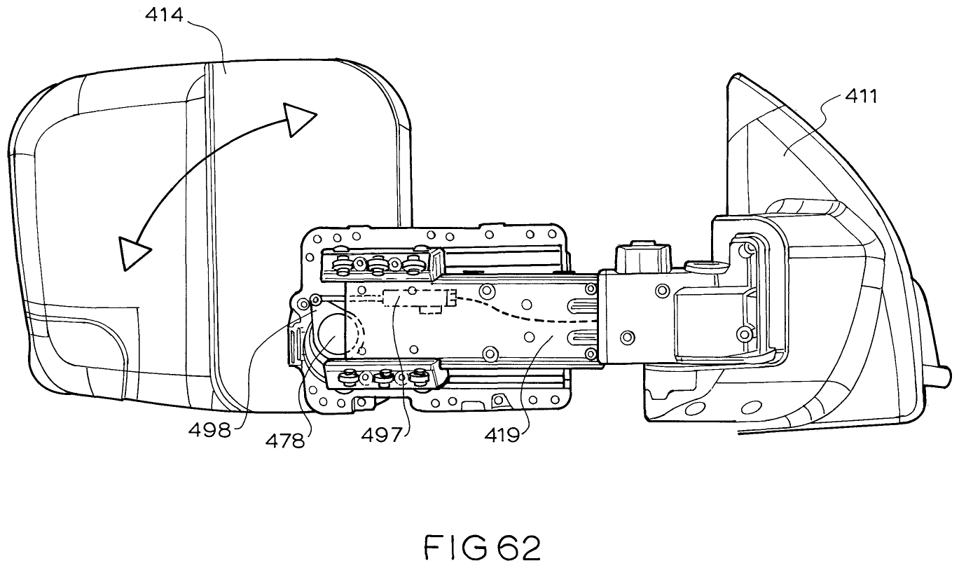

FIG. 62 is an elevation of the towing mirror of FIG. 52 viewed from the same position with the extension component extended and the mirror component rotated to the fully extended or outer position and actuated by a linear actuator and crank arm; and

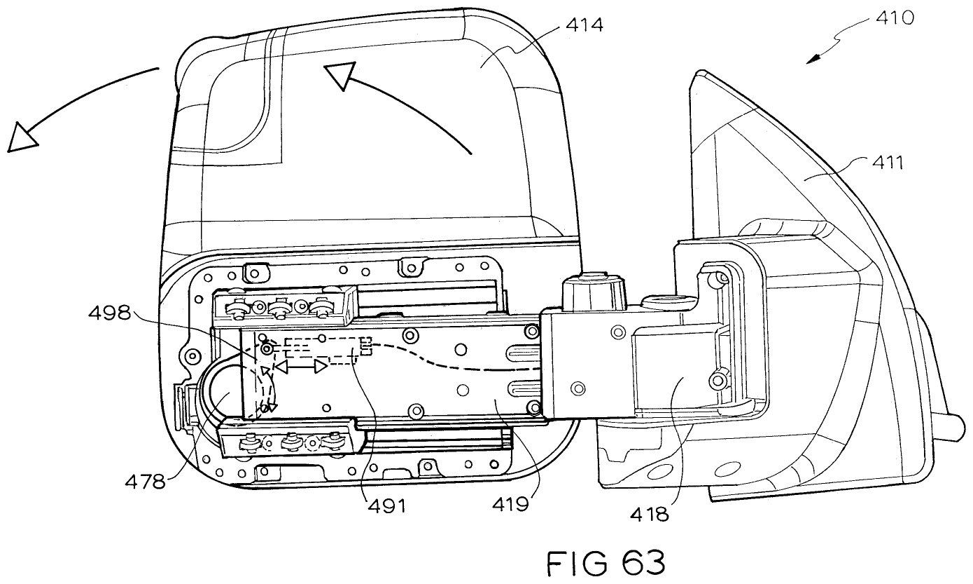

FIG. 63 is an elevation of the towing mirror of FIG. 52 viewed from the same position as in FIG. 62 with the extension component retracted and the mirror component rotated to the inner position and actuated by a linear actuator and crank arm.

The applicant's earlier towing mirror or mirror assembly 10 illustrated in FIGS. 1 to 31 includes a mount 11 adapted to be mounted to the outer skin of the door of a vehicle, an extension component 12 connected at one end to the mount 11 by a vertical pivot pin 13, and a mirror or mirror component 14 connected to the other end of the extension component by a horizontal pivot pin 16 which can be more clearly seen in FIG. 15. Suitably, the mount 11, the extension component 12, and other load-bearing components are constructed of aluminium alloy which are covered by various cover is which are constructed of a plastics material.

Advantageously, the extension component 12 comprises a first member 18 to which the vertical pivot pin 13 is fixed at its proximal or inner end and a second member 19 which is slidably mounted on the first component for longitudinal movement relative thereto along a horizontal axis 20 shown in FIG. 1, that is, towards and away from the mount 11 as required. Notably, the pivot pin 13 is engaged in a complementary bore provided in the mount and secured therein by a circlip or similar means (not shown) for pivoting movement relative to the mount about a vertical axis 21. Notably, the first member is substantially rectangular in outer shape and slides in a complementary generally rectangular shaped cavity in the second member, the rectangular shape of both being such as to prevent relative rotation between the two components about the horizontal axis 20. In other versions, the first member 18 is not mounted to pivot about a vertical axis but instead is cast with the mount 311 and in such cases, the towing mirror cannot be folded to a position immediately adjacent the vehicle cabin as in the version illustrated.

The mirror component 14 in turn is mounted to the outer or distal end of the second member 19 of the extension component for pivoting movement about a horizontal axis 23 which extends generally in the direction of travel of the vehicle to which the mount 11 is to be secured.

It will be appreciated that the mirror is in the retracted position shown in FIGS. 1 to 6 for normal non-towing driving of the vehicle. In that position, the mirror is relatively close to the vehicle cabin to which the mount is secured with the extension component fully retracted with the first extension member almost fully encompassed by the second extension member while the mirror component is disposed almost fully behind the extension component, that is, in a position most proximal to the vehicle cabin.

It will also be appreciated that the mirror is in a first extended position shown in FIGS. 7 to 14 whereby the extension component 12 is fully extended, that is, with the second extension member drawn along the first extension member so that the mirror component is in a middle disposition further from the vehicle cabin but in the same attitude as shown in FIGS. 1 to 6.

Further, it will also be appreciated that the mirror is in a second or fully extended position shown in FIGS. 15 to 22 whereby the extension component 12 is fully extended as in FIGS. 7 to 14 but in the fully extended position the mirror component has been rotated through 90° in a clockwise direction when viewed from the rear of the vehicle thereby placing the mirror component further from the vehicle and in its most distal position. This is achieved by the horizontal pivot pin 16 being mounted in corner portion 31 of the mirror component, that corner portion being the outermost portion when in the retracted position and then becoming the innermost portion when in the extended disposition.

As can be more clearly seen in FIG. 31, the horizontal pivot pin 16 extends from a lower outermost corner 41 of the second extension member or portion 19 and is arranged so that it fits into a recess 42 provided in the first extension member when the extension component is fully retracted. Advantageously, such arrangement allows the extension component 12 to maximise its slidable length while at the same time maximises the vertical and horizontal extent to which the mirror component can pivot about the horizontal axis 16 thereby maximising the extension of the towing mirror. It will be appreciated that selection of different shaped mirrors provides for higher or wider vision depending on the circumstances but the minimum width of the retracted mirror assembly is substantially determined by the width of the mirror when in the fully retracted position and that width determines the height of the mirror when in the 90° arc position as shown in FIG. 15 or the 180° arc position (not shown).

Various positions of the extension component can be set by way of a spring-loaded detent in one component engaging with a mating seat in the other component. Thus, the extension component might have an inner position seat, an outer position seat and one or two intermediate seats so that any desired one of those positions can be selected. Similarly, a spring-loaded detent can be provided in the mirror component to engage with a 0° arc seat in the outer extension member, a 90° arc seat and a 180° arc seat if desired to achieve the desired purpose.

The towing mirror 310 illustrated in FIG. 32 is similar to the applicant's previous towing mirror 10 illustrated in FIGS. 1 to 31 in many respects and consequently, corresponding reference numbers are used to reference corresponding features except prefaced by a “3”.

While the extension component 312 comprises a first member 318 and a second member 319 which moves linearly relative to the first member as in the towing mirror of FIGS. 1 to 31, in this mirror the second member moves more easily and chattering due to vibration is largely eliminated especially in the fully extended position. These advantages are achieved in the present embodiment by incorporating a carriage assembly 350 into the first member and incorporating a two-part housing 370 with tracks provided therein in the second member as will now be described.

As can be seen in part in FIG. 35 and FIGS. 43 to 50, the second member 319 includes a housing 370 having a first half 371 and a second half 372. While this description refers to “halves” in relation to the housing, the halves are not necessarily geometric halves but rather are two parts of different sizes and shapes which go together to form housing 370.

Housing 370 defines a cavity 373 in which the carriage assembly 350 can travel in a forward and reverse manner along the horizontal axis or an axis parallel to the horizontal axis. Notably, first housing half 371 has an inner face 371a with spaced apart first tracks 371b and 371c extending in the longitudinal direction and which in use are vertical. While this description suggests that the carriage travels, that travelling is only travel relative to the housing because the carriage assembly 350 is fixed and the housing 370 is the component that actually travels. However, because the housing incorporates the tracks and the carriage incorporates the wheels and so acts more like a carriage in a relative sense, this description refers to the component with the wheels as the carriage.

Second housing half 372 which is secured to first housing half by a plurality of screws or bolts fitted about the respective perimeters has an inner face 372a comprising a generally vertical face 372b and two inclined faces 372c and 372d opposite each other and two opposed parallel horizontal planar faces 372e and 372f extending from opposite sides of the inclined faces respectively and terminate in outwardly extending flanges 374a and 374b. The inclined faces 372c and 372d each make an angle of 45° to the vertical plane and to horizontal faces 372e and 372f and each form spaced apart second tracks generally opposite and parallel to tracks 371b and 371c of the first housing half respectively but making an angle of 45° thereto also.

Carriage assembly 350 forms an end part of the first member 318 and is arranged to travel within housing 370 as can be seen in FIG. 34. The carriage assembly includes an aluminium alloy mounting block 351 comprising a main block 352 and two spaced apart subsidiary blocks 353 and 354 which are mounted to the main block. Notably, the subsidiary blocks have respective faces 353a and 354a respectively which make an angle of 45° to the vertical and correspond with inclined faces 372c and 372d of the second housing half respectively. The main mounting block also has opposed top and bottom horizontal faces 352e and 352f which correspond with or complement inner horizontal faces 372e and 372f provided in the second housing half.

Two spaced apart load-bearing axles 356 and 357 are mounted to the main block on one side, each of those axles having free running wheels 356u and 356v or 357u and 357v rotatably mounted at the respective ends. A third axle 358 is mounted midway between the load-bearing axles 356 and 357 and has a double set of wheels 358u and 358v mounted midway between its two ends, the double set of wheels being arranged to function as a travel stopper as will be described in more detail later.

It will be appreciated from FIG. 34 that wheels 356u and 356v and wheels 357u and 357v are arranged to roll on tracks 371b and 371c in the first housing half 371 and that double wheels 358u and 358v are arranged to engage in stopper recesses 375a and 375b to stop movement of the carriage in one direction or the other which will be appreciated from FIG. 45.

Advantageously, the two load-bearing axles 356 and 357 as well as the third (or stopper) axle 358 are supported on spring-loaded mounts or “pistons” which bias the axles outwards from the mounting block. In that respect, the main mounting block has two spaced apart cylindrical recesses therein aligned with each axle, and a compression spring (not shown) is mounted in each recess with a mounting block slidably mounted in each recess and engaged with the spring whereby the spring biases mounting block outwards.

The spaced apart subsidiary blocks 353 and 354 also have axles and wheels mounted thereto in their respective 45 degree faces with each subsidiary block having three single wheels 353u, 353v and 353w or 354u, 354v and 353w respectively mounted therein, the three wheels of each set being in line with each other. Notably, the three axles in each set are fixed in position, that is, the wheels can only roll and do not have any variable suspension or bias.

It will be appreciated from FIG. 34d that the three wheels in the subsidiary blocks are arranged to roll on respective inclined faces 353a and 354a.

Two further sets of two spaced apart wheels 352u and 352v and 352w and 352x are mounted to the mounting block on the opposite sides in recesses extending from the opposite horizontal faces and are intended to run on the corresponding or complementary faces 372e and 372f of the second housing half. Although some faces are referred to as being “horizontal”, those faces in some embodiments have a slight taper to assist in assembly. In some cases, such faces in the housing may be slightly tapered or the faces of the mounting block of the carriage may be slightly tapered or in some cases, the faces might be tapered on both the carriage and the housing.

It will be appreciated that the carriage assembly 350 is mounted in the cavity 342 of the housing 370 so that wheels 352u and 352v as well as their corresponding wheels on the other ends 352w and 352x run on tracks 371b and 371c respectively of the first housing half on one side of the mounting block while opposite wheels 354u,354v,354w on the two inclined faces of the subsidiary blocks run on inclined faces 372c and 372d of the second housing half 372, the two housing halves effectively clamping the carriage within the cavity 373 but allowing linear travel within the housing. Advantageously, inclined faces of the housing substantially prevent lateral movement of the carriage within the housing.

Additionally, wheels 352u, 352v, and opposite wheels 352w, 352x roll on the horizontal faces in the second housing half thereby further inhibiting lateral movement of the carriage, those wheels being mounted towards the first housing half so as to inhibit movement of the main mounting block.

Importantly, the spring-loaded mounts or pistons which bias the axles outwards from the mounting block ensure that the carriage is held tight against the tracks in the first housing half and against the inclined tracks in the second housing half. Also, the wheels which run against the upper and lower horizontal faces 372e and 372f, support the vertical load applied by the mirror component and the combination of two spaced apart wheels on the upper side of the main mounting block and corresponding spaced apart wheels on the lower side of the main mounting block inhibit rocking of the second extension member relative to the first extension member, the wheels which are diagonally opposite carrying the moment load.

Further, double (or stopper) wheels 358u and 358v are also biased but for the purpose of allowing them to sit in the stopper recesses when the mirror is in its retracted or extended position and to ride out of the recesses to allow movement from one position to the other.

It will also be seen that a recess 378 extends forward (towards the front of the vehicle) from inner face 371a of the first housing part and terminates in an inwardly extending flange 379 which forms a base for a hollow shaft 382 by which the mirror component is pivotally mounted to the second extension member 319. Suitably, the hollow shaft provides a passage by which electric cables can pass from the extension components to the mirror component. Advantageously, as can be seen in FIG. 50, two spaced apart fins 377a and 377b extend from inner face 372b of the second housing half into the cavity 373 and provide protection for such electric cables and prevent the cables jamming between the carriage and the housing.

Various cowls and covers are shown in the drawings relating to towing mirror 310 which are much the same as in mirror 10 so have not been described.

The towing mirror 410 illustrated in FIG. 52 is similar to the towing mirror 310 illustrated in FIGS. 32 to 51 in many respects and consequently, corresponding reference numbers are used to reference corresponding features except commencing with a “4” rather than a “3”

The towing mirror 410 illustrated in FIGS. 52 to 63 differs from towing mirror 310 in a number of ways, the first being that folding and unfolding of the mirror relative the vehicle door is achieved by way of an electric motor 485 which is actuated by a switch in the cabin of the vehicle.

The second difference is that movement of the extension component 412 from the retracted position to the extended position and vice versa is achieved by way of a linear actuator as can be seen in FIGS. 57 and 58 or alternatively by an electric motor with a rack and pinion arrangement as can be seen in FIGS. 59 and 60. In both cases actuation is controlled by a switch in the cabin of the vehicle. In the linear actuator option, the actuator includes a push pull mechanism having a cylinder 489 which is fixed to the second extension member 419 by way of a pivoting end mount 488 and a push rod 487 which is driven by a motor 490. In the rack and pinion option, the rack 491 includes a plurality of gear teeth which are cast into the housing half 471 of the second extension member 419 and a complementary motor 492 which is mounted to the second extension component 419.

The third difference is that pivoting of the mirror component 414 about horizontal axis 416 is also achieved by way of an electric motor 493 with a gear drive 494 as can be seen in FIG. 61 which is also controlled by a switch in the cabin of the vehicle. Suitably, the gear drive includes a pinion gear 495 on the motor drive shaft and a complementary crown gear 496 on the mirror mounting shaft 478. In the alternative shown in FIGS. 62 and 63, the mirror component 414 is pivoted by way of a linear actuator 497 connected to extension member 419 and attached to a crank arm 498 which in turn is fixed to mirror mounting shaft 478 in a manner so as to pivot that shaft and the mirror component 414 therewith through an arc of 90 degrees.

While the foregoing description has been given by way of illustrative example of the invention, it will be understood that the invention may be embodied in many other forms and all such forms are deemed to fall within the broad scope and ambit of the invention as hereinbefore described.

1. A towing mirror including:
a mount adapted to be mounted to a vehicle cabin;
an extension component including a first member and a second member, said first member being operatively connected at one end to said mount for pivoting movement relative thereto about a generally vertical axis and said second member being adapted to move relative to said first member from a retracted position to an extended position and vice versa; and wherein
one of said first and second members includes one or more tracks and the other includes one or more carriages, said one or more tracks and said one or more carriages being arranged such that said one or more carriages run on or against said one or more tracks whereby said second member may move linearly relative to said first member from the retracted position to the extended position and vice versa; and
a mirror component operatively connected to said second member for pivoting movement relative thereto about a generally horizontal axis extending substantially in the intended direction of travel of the vehicle cabin to which the mirror is to be mounted and spaced from said vertical axis.

2-4. (canceled)

5. A towing mirror according to claim 1 wherein said one or more carriages and/or said one or more tracks include mobility assistance means and/or friction reduction means.

6. A towing mirror according to claim 5 wherein said mobility assistance means include wheels, rollers, balls, bearings and/or friction reduction means including low friction sleds or runners.

7. (canceled)

8. A towing mirror according to claim 1 wherein said one or more carriages and/or said one or more tracks includes stabilisation means for stabilising said one or more carriages on said one or more tracks.

9. A towing mirror according to claim 8 wherein said mobility assistance means and/or said friction reduction means incorporates said stabilisation means, whereby lateral movement of the second component relative to the first component is substantially inhibited in all directions except the intended linear movement direction.

10. A towing mirror according to claim 9 wherein said stabilisation means includes biasing means for biasing at least some of said one or more carriages in a predetermined direction relative to said extension component.

11. A towing mirror according to claim 10 wherein said one or more carriages run between two sets of tracks and said biasing means biases said carriages into engagement with said two sets of tracks thereby stabilising the carriages between said sets of tracks.

12. A towing mirror according to claim 11 wherein one of said two sets of tracks includes two spaced apart tracks provided on converging inclined planes and the other set includes two spaced apart tracks provided on a vertical plane.

13. A towing mirror according to claim 12 wherein the converging inclined planes are orthogonal to each other.

14. A towing mirror according to claim 13 wherein the inclined planes are at about 45 degrees to the vertical plane and converge away from the other set of tracks.

15. A towing mirror according to claim 14 wherein one set of tracks is provided on a vertical plane and one set of tracks is provided on converging inclined planes, such planes converging away from the vertical plane.

16. A towing mirror according to claim 15 wherein the biasing means bias the one or more carriages towards the tracks provided on the inclined plane.

17. A towing mirror according to claim 16 wherein the biasing means apply a biasing force to the mobility assistance means whereby they are biased towards engagement with the vertical tracks thereby pushing the one or more carriages into engagement with the inclined planes.

18. A towing mirror according to claim 17 wherein a third set of tracks is provided on said one or more carriages to constrain movement of said one or more carriages in the vertical direction thereby constraining up-and-down movement in use of the second member relative to the first member.

19. A towing mirror according to claim 18 wherein the third set of tracks includes a lower track on which the one or more carriages run under the influence of gravity and an upper track arranged to prevent tilting of the second member relative to the first member while allowing linear travel of the second member relative to the first member.

20. A towing mirror according to claim 19 wherein said one or more carriages include stop means for stopping linear movement of at least one of said one or more carriages relative to said one or more tracks.

21. A towing mirror according to claim 20 wherein said stop means includes a stop member mounted to one of said first and second members and a complementary recess in the other of said first and second members, said stop member being adapted to engage at least partially in said recess to selectively inhibit or stop said linear movement at a desired limit of movement.

22. A towing mirror according to claim 21 wherein said stop member includes a wheel or roller adapted to engage said recess.

23. A towing mirror according to claim 22 wherein said wheel or roller is biased towards the engaged position whereby it is urged into the recess at the desired limit of linear movement.

24. A towing mirror according to claim 23 wherein said stop means includes two spaced apart recesses, one at the limit of selected travel in one direction and the other at the limit of selected travel in the opposite direction.

25. (canceled)

26. A towing mirror according to claim 24 wherein said second member includes a housing having an opening adapted to receive therethrough at least a portion of said first member.

27. A towing mirror according to claim 26 wherein one of said one or more sets of tracks is provided on a first inner face of said housing and one of said one or more carriages is provided on said at least a portion of said first member.

28. A towing mirror according to claim 27 wherein a set of two spaced apart orthogonal inclined second tracks are provided on another or other faces spaced from and generally opposite (although inclined relative to) said first inner face and that said first member includes at least one carriage, said at least one carriage including first mobility assistance means arrange to run on said one set of tracks and second mobility assistance means arranged to run on said second set of tracks.

29. A towing mirror according to claim 28 wherein said biasing means is arranged to bias the mobility assistance means into engagement with the respective first tracks and second tracks so that said first member is constrained to engage said one set of tracks and said second set of tracks at the same time thereby inhibiting lateral movement of the first member relative to the second member.

30. A towing mirror according to claim 29 including a third set of tracks, one track of said third set of tracks being on a third inner face of the housing generally orthogonal to the first inner face and an opposing track on a fourth inner face opposite the third inner face and generally parallel thereto.

31-32. (canceled)

33. A towing mirror according to claim 30 wherein the housing includes at least two components and said one set of tracks provided on said first inner face of said housing is in a first component and said two spaced apart orthogonal inclined second tracks are provided in a complementary second component adapted to be secured to said first component.

34. A towing mirror according to claim 33 wherein the first member is fitted to the first component of the housing with the one or more carriages resting in the first component and the first mobility assistance means is arranged on said one set of tracks and the second component of the housing then is fitted to the first component so as to lock the one or more carriages within the housing such that the second mobility assistance means runs on the second set of tracks.

35-37. (canceled)

38. A towing mirror including:
an extension component including a housing and a carriage, said housing forming a plurality of spaced apart tracks or having a plurality of spaced apart tracks therein and said carriage including mobility assistance means adapted to run on said tracks, at least some of said mobility assistance means being biased towards one track or one set of tracks so as to force other mobility assistance means into engagement with other tracks, said tracks and said carriage being arranged to substantially restrain said carriage against movement in a lateral direction.

39-40. (canceled)

41. A towing mirror according to claim 1 including an electrically powered actuator or motor arranged to pivot said first member of said extension component relative to said mount about said generally vertical axis.

42. A towing mirror according to claim 41 including an electrically powered actuator or motor arranged to selectively extend and retract said second member of said extension component relative to said second component of said extension component.

43. A towing mirror according to claim 42 including an electrically powered actuator or motor arranged to pivot or rotate said mirror component relative to said extension component about said horizontal axis.

44-45. (canceled)
